(19) United States
(12) Patent Application Publication
(10) Pub. No.: US 2009/0092766 A1
(43) Pub. Date: Apr. 9, 2009

(54) GRAFT PATTERN FORMING METHOD AND CONDUCTIVE PATTERN FORMING METHOD

(75) Inventors: Koichi Kawamura, Kanagawa (JP); Yasuaki Matsushita, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/914,977

(22) PCT Filed: May 18, 2006
(86) PCT No.: PCT/JP2006/310414

§ 371 Date: Nov. 20, 2007

(30) Foreign Application Priority Data
May 20, 2005 (JP) 2005-148359

(51) Int. Cl. B05D 3/06

(52) U.S. Cl. 427/510

(57) ABSTRACT

The invention provides a graft pattern forming method including contacting a radical-polymerizable unsaturated compound with a surface of a base material capable of generating radicals by exposure; and exposing imagewise with laser light having a wavelength of 360 to 700 nm to form a graft polymer directly bonded to the base material patternwise on the surface of the base material. The invention also provides a conductive pattern forming method including imparting conductivity to the graft pattern formed patternwise obtained by the graft pattern forming method.

### TECHNICAL FIELD

The present invention relates to a graft pattern forming method and a conductive pattern forming method, and more particularly to a graft pattern forming method capable of forming a high definition graft pattern to which moisture or materials having various functions can be applied, and a conductive pattern forming method capable of easily forming a conductive pattern of high definition and having an excellent conductivity using the graft pattern forming method.

### BACKGROUND ART

In recent years, techniques of establishing antifouling properties, hydrophilicity and other various functions on solid surfaces have come under scrutiny and, among these, techniques aimed at modifying a solid surface by applying a function of graft polymer formed with only one end terminal directly bonded to a substrate, have been variously investigated.

In particular, with the miniaturization of electronic materials, a method for easily forming high-definition electrical wiring is demanded.

Micro wiring having high-definition and excellent conductivity is generally formed by a gas phase method such as a vacuum filming method; however, it is difficult to form a metal film having uniform film thickness and film property over a wide area by this method, and a formation method of highly reliable wiring and electrodes is required. In addition, the problem arises in that large capital investment is required when metal film is formed on a large area of panel by the gas phase method, since collateral equipment such as a huge vacuum filming machine and gas provision equipment are required. Additionally, vacuum filming machines such as a sputter apparatus or a CVD apparatus require a large amount of electricity for driving a vacuum pump, performing substrate heating, generating plasma, and thus the additional problem arises that energy expenditure for the manufacturing equipment obviously increases due to the increase in size.

In addition, conventionally, when forming metal wiring or the like, an electrical wiring pattern is formed by forming a metal film on an entire surface of a substrate by use of a vacuum filming machine, and then eliminating an unnecessary portion by etching; however, in this method, the problem arises that the resolution of the wiring is limited and metal materials are wasted. In recent years, reductions in energy expenditure for a manufacturing process and efficient use of material resources are demanded in view of environmental concerns, and a method for more easily forming a metal film pattern having a desirable resolution is required.

In this respect, for example, an electroless plating technique (see, for example, Japanese Patent Application Laid-Open (JP-A) No. 2000-147762) including arranging in advance a catalytic layer, which is required for the electroless plating reaction, in a pattern on a substrate and selectively forming metal films only in regions where the catalytic layer is present, or a method including forming a metal oxide film (for example, ZnO) on a substrate surface and then performing patterning of the metal oxide film, and finally selectively forming a metal film pattern on the formed metal oxide film pattern (see, for example, JP-A No. 2001-85358) have been proposed. According to these methods, it is possible to form a metal wiring in a desirable pattern, however the problems arise that in the former method, adhesion of the substrate and the plated film is extremely weak when a metal film pattern is formed by electroless plating on a substrate having a smooth surface such as a glass substrate, which causes significant practical problems and, further, it is difficult to increase the film thickness of the plating film. In the latter method, it is necessary to use a resist resin or the like in the process of patterning a zinc oxide film formed on an entire substrate and the process is complicated. Further, delicate adjustment of the etching rate is required due to the reduced chemical resistance of zinc oxide and it is difficult to improve in-plane uniformity of the etching rate in a large area substrate.

In addition, as an improved technology, a method for forming a metal pattern by electroless plating has been proposed (see, for example, JP-A No. 2003-213436), where the method includes using a photosensitive film supporting a material which is to be the catalyst, forming a catalytic layer patterned by ultraviolet exposure, forming a zinc oxide film only in this region, and making this the start point of forming a metal pattern by electroless plating. The method has an advantage in that a zinc oxide film pattern having high resolution is formed; however, it requires a specific material such as a photosensitive film and the process until the metal film is formed is complicated as it requires five procedures including formation of two catalytic layers.

In response, conductive pattern materials capable of directly forming an image on the basis of digital data by operating an infrared laser, and a forming method thereof have been proposed (see, for example, JP-A No. 2003-114525). However, there is room for improvement in the storage stability of the image formation component used in here because a polarity changing function is applied. Additionally, it was necessary to obtain a high-definition conductive pattern in which resolution and definition are improved further, and in order to achieve the high-resolution, a laser exposure method having a short exposure time and a rapid scanning rate has been investigated. However, the high-power infrared laser used in this method requires a large capital investment since the exposure equipment used has a high cost, and thus a method using exposure equipment with a visible range with high productivity at a lower cost is required.

### DISCLOSURE OF INVENTION

The present invention has been made in view of the above circumstances, and provides a graft pattern forming method and a conductive pattern forming method.

The inventors found that the above problems can be overcome by forming a graft polymer through radical polymerization on a base material surface capable of initiating radical polymerization by applying energy, and achieved the invention.

A first aspect of the invention provides a graft pattern forming method including contacting a radical-polymerizable unsaturated compound with a surface of a base material capable of generating radicals by exposure; and exposing imagewise with laser light having a wavelength of from 360 to 700 nm to form a graft polymer directly bonded to the base material patternwise on the surface of the base material.

A second aspect of the invention provides a conductive pattern forming method including imparting conductivity to the graft polymer formed patternwise obtained by the graft pattern forming method of the first aspect of the invention.

### BEST MODE FOR CARRYING OUT THE INVENTION

Hereinafter, the invention will be described in detail.

The graft pattern forming method of the invention includes (1) contacting a radical-polymerizable unsaturated compound with a surface of a base material capable of generating radicals by exposure; and (2) exposing laser light having a wavelength in the range of 360 nm to 700 nm thereto imagewise, to form a graft polymer directly bonded to the base material patternwise on the surface of the base material.

In the imagewise exposure, laser scanning exposure with maximum absorption in a visible range, which is the range of wavelength from 360 nm to 700 nm, is used.

According to the invention, since a light source of visible range, which is in the range of wavelength from 360 nm to 700 nm, is selected as a light source for exposure, it is possible to form a pattern having higher resolution, compared with those obtained by the conventional pattern forming method using scanning exposure of infrared range, or ultraviolet range. Therefore, the conductive pattern obtained by using this graft pattern can form a wiring with higher resolution.

Firstly, a base material capable of generating radicals by exposure is prepared. For the base material, as long as it can generate radicals by laser exposure at a wavelength in the range of 360 nm to 700 nm, any base material may be used.

Examples of the base materials capable of generating radicals by exposure include (a) a base material containing a radical generator, (b) a base material containing a polymer compound having a radical generating moiety, and (c) a base material having a coated layer, having a cross-linked structure formed therein, on a surface of the base material, wherein the coated layer is formed by coating a support surface with a coating solution containing a cross-linking agent and a polymer compound including a radical-generating moiety, and drying the coating solution.

In a preferable embodiment of the invention, a graft polymer is formed by a method including bonding a compound capable of initiating polymerization at an entire surface of a glass substrate or the like, exposing laser light having a wavelength in the range of 360 nm to 700 nm thereto patternwise as desired, thereby activating patternwise a polymerization initiating moiety included in the compound, which is used as a starting point of the graft polymer.

Examples of the compounds capable of initiating polymerization which can be used in the embodiment include a compound having a polymerization initiating moiety (Y) which can undergo photocleavage to initiate radical polymerization and a base material bonding moiety (Q) (which, hereinafter may sometimes be referred to as “photocleavable compound (Q-Y)”).

Herein, the polymerization initiating moiety (hereinafter, referred to as “polymerization initiating moiety (Y)”) which can undergo photocleavage to initiate radical polymerization is in a structure containing a single bond which can be cleaved by application of light.

Examples of the single bonds which can be cleaved by application of light include single bonds which can be cleaved by using α-cleavage of carbonyl, β-cleavage of carbonyl, light-free rearrangement reaction of carbonyl, cleavage reaction of phenacyl ester, cleavage reaction of sulfonimide, cleavage reaction of sulfonyl ester, cleavage reaction of N-hydroxysulfonyl ester, cleavage reaction of benzylimide, and cleavage reaction of active halogen compounds or the like. Single bonds which can be cleaved by application of light are cleaved through the reactions. Examples of the single bonds which can be cleaved include a C—C bond, a C—N bond, a C—O bond, a C—Cl bond, a N—O bond, and a S—N bond.

In addition, since the polymerization initiating moiety (Y) containing a single bond which can be cleaved by application of light is the starting point of the graft polymerization in a graft polymer formation process, it has an ability to generate radicals by a cleavage reaction when the single bond which can be cleaved by application of light is cleaved. Examples of structure of polymerization initiating moiety (Y) capable of generating radicals and having a single bond which can be cleaved by application of light include those containing any of the following groups.

An aromatic ketone group, a phenacyl ester group, a sulfonimide group, a sulfonyl ester group, an N-hydroxylsulfonyl ester group, a benzylimide group, a trichloromethyl group, a benzylchloride group, and the like.

When radicals are generated by cleavage of such polymerization initiating moiety (Y) and a polymerizable compounds is present around the radicals, a graft polymer can be formed since the radicals function as a starting point of the graft polymerization reaction.

Therefore, if a graft polymer is formed by use of a base material in which a photocleavable compound (Q-Y) is introduced to the surface thereof, it is necessary to use exposure as a means for applying energy, at a wavelength which can cleave a polymerization initiation moiety (Y).

The base material bonding moiety (Q) includes a reactive group capable of reacting with a functional groups (Z) present on a surface of an insulating substrate (typical examples thereof including glass) to undergo bonding. Specific examples of the reactive groups include groups described below.

Q: base material bonding group

—Si(OMe)₃-SiCl₃—NCO—CH₂Cl

The polymerization initiating moiety (Y) and the substrate bonding moiety (substrate bonding group) (Q) may be bonded to each other directly or bonded via a linking group. Examples of the linking groups include linking groups containing atoms selected from the group consisting of carbon, nitrogen, oxygen, and sulfur. Specific examples include a saturated carbon group, an aromatic group, an ester group, an amide group, an ureido group, an ether group, an amino group, and a sulfonamide group. Also, the linking groups may further have a substituent group and the examples the substituent groups which can be introduced to the linking group include an alkyl group, an alkoxy group, and a halogen atom.

Specific examples [exemplary compounds T1 to T5] of the compounds (Q-Y) having the substrate bonding moiety (Q) and the polymerization initiating moiety (Y) will be shown below together with cleavage sites, but the invention is not limited to these.

C—Cl bond cleavage type

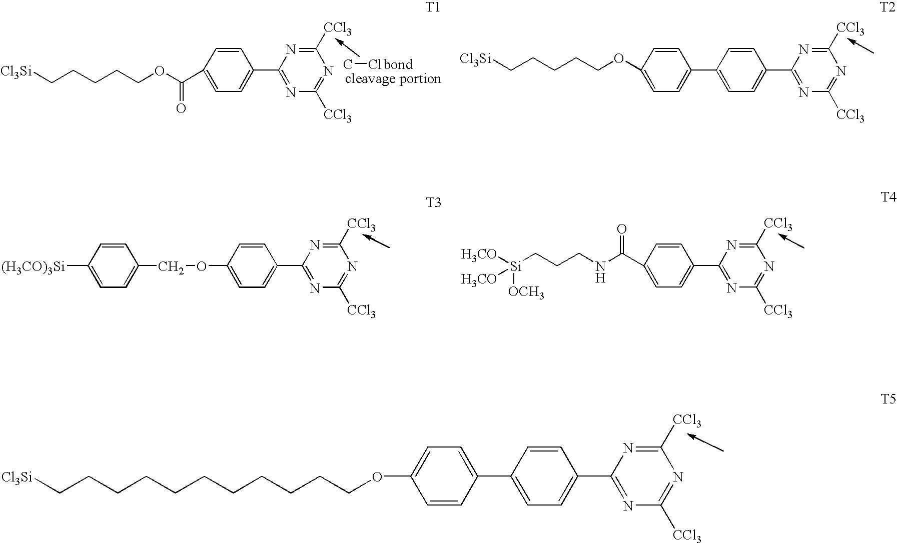

When a glass substrate is used, a functional group (Z) such as a hydroxyl group is present from the beginning on a substrate surface which to be used in the invention, due to the material. Therefore, the photocleavable compound (Q-Y) can be easily introduced to the base material surface by contacting the photocleavable compound (Q-Y) onto the glass substrate and then bonding the functional group (Z) that is present on the base material surface to a base material bonding moiety (Q). When a resin substrate is used as an insulating substrate, a hydroxyl group, carboxyl group or the like may be generated by a surface treatment such as a corona treatment, glow treatment, plasma treatment or the like to the substrate surface, and these functional groups (Z) may become as the starting point.

Examples of the glass substrate to be used in the invention as an insulating substrate include a silicon glass substrate, a non-alkaline glass substrate, a silica glass substrate, and a substrate formed by forming an ITO film on a glass substrate surface. Thickness of the glass substrates is not limited and it may be selected according to their purpose of use, but it is generally in the range of about 10 μm to 10 cm.

Specific examples of the methods for bonding a photocleavable compound (Q-Y) to a functional group (Z) that is present on a base material surface include a method including dissolving or dispersing a photocleavable compound (Q-Y) into an suitable solvent such as toluene, hexane, or acetone, and then coating the base material surface with the solution or the dispersion, or immersing the base material into the solution or the dispersion. In this manner, the base material surface in which the photocleavable compound (Q-Y) is introduced can be obtained.

The concentration of the photocleavable compound (Q-Y) in the solution or the dispersion is preferably in the range of 0.01 to 30% by mass, and is more preferably in the range of 0.1 to 15% by mass. The temperature of the solution or dispersion to be in contact with the base material is preferably in the range of 0 to 100° C. The time during which the solution or dispersion comes in contact with the base material is preferably in the range of 1 second to 50 hours and is more preferably in the range of 10 seconds to 10 hours.

Also, at this time, a sensitizer, which will be described later, may be coexisted together with the compound having radical generating ability.

In order to form a graft polymer on the surface of the base material obtained by the aforementioned manner in which photocleavable compound (Q-Y) is introduced to the surface, a method including contacting a polymerizable compound with the surface, and cleaving the polymerization initiating moiety (Y) of exposed region by performance of pattern exposure, so as to make this as a starting point to form a graft polymer, may be used.

Also, a graft polymer can be formed patternwise by a method described below.

Firstly, on a base material surface in which a photocleavable compound (Q-Y) is introduced, pattern exposure is previously performed along a region not intended to form a graft polymer, so as to form a region capable of initiating polymerization and a region in which polymerization initiating ability is deactivated on a base material surface by deactivating the polymerization initiating ability through photocleavage of the compound (Q-Y) bonded to the base material surface. Next, a polymerizable compound is contacted to the base material surface in which the region capable of initiating polymerization and the region in which polymerization initiating ability is deactivated are formed, and a graft polymer is formed only in the region capable of initiating polymerization by a performance of exposure to an entire surface, and as a result, the graft polymer is formed patternwise.

In order to form a graft polymer in the aforementioned manner, it is necessary to contact a polymerizable compound, which is in a state of single compound or dispersed or dissolved in a solvent, with a base material surface in which a photocleavable compound (Q-Y) is introduced. The contacting method may be carried out by immersing the base material into a liquid composition containing the polymerizable compound. From the viewpoints of handleability and production efficiency, it is more preferable to be carried out by contacting the polymerizable compound as it is, or by forming a coating film by coating of the liquid composition containing a polymerizable compound, or by further drying the coating film to form a layer (graft polymer precursor layer) containing a polymerizable compound on the base material surface.

Among these, the contacting is preferable to be carried out by coating a liquid composition containing the polymerizable compound and the a sensitizer having maximum absorption at a wavelength of from 360 to 700, and drying it to form a graft polymer precursor layer containing the sensitizer, from the view point of graft polymer pattern forming efficiency.

The method for forming a graft polymer in the invention is not limited to the aforementioned methods and there are other embodiments including the embodiments described below.

Other than a method <1> including using a solid which can generate radicals by exposure, contacting a compound containing a polymerizable unsaturated double bond with a surface of the solid, and then performing exposure patternwise, and finally graft polymerizing the compounds by making radicals generated by exposure on the base material surface as a starting point, thereby forming a graft polymer imagewise, a method <2> including generating an active point by contacting a hydrogen abstraction typed radical generator with a solid surface, and performing exposure imagewise can be suggested as an embodiment, and in this case, active point generation and graft polymer formation progress at the same time when a polymerizable compound is contacted.

In addition, a method <3> including providing a photo-polymerization initiating moiety which can undergo photocleavage to initiate radical polymerization on a solid surface patternwise by covalently bonding and using it as a starting point to form a graft polymer, is preferably suggested. The methods for obtaining such solid surface include a method deactivating the photo-polymerization initiating moiety of an exposed region by first binding a compound to a base material, wherein the compound contains a photo-polymerization initiating moiety which can undergo photocleavage to initiate radical polymerization and a base material bonding moiety, and then performing pattern exposure; and a method binding a compound patternwise to a solid surface, wherein the compound contains a polymerization initiating moiety which can undergo photocleavage to initiate radical polymerization and a base material bonding moiety.

Also, following base materials can be used for a base material capable of generating radicals by exposure or for an insulating layer, which are to be used in the embodiment <1>. Examples thereof include (a) a base material containing a radical generator, (b) a base material containing a polymer compound having a radical generating moiety on a side chain, and (c) a base material having a coated layer having a cross-linked structure formed therein, wherein the coated layer is formed by coating a support surface with a coating solution containing a cross-linking agent and a polymer compound including a radical-generating moiety on a side chain, and drying the coating solution.

“A compound which can generate radicals by exposure (which, hereinafter may sometimes be referred to as a radical generator)” contained in the representative substrate (a) may be a low-molecular weight compound or a polymer compound and the ones generally known may be used.

As a low-molecular weight radical generator, generally known radical generators may be used and the examples thereof include acetophenones, benzophenones, Michler's ketone, benzoylbenzoate, benzoins, α-acyloximester, tetramethyl thiuram mono-sulfide, triazines such as trichloromethyltriazine, and thioxanthone. Also since sulfonium salts and iodonium salts which are generally used as a photo acid generator act as a radical generator by light irradiation, these may be used in the invention.

As a polymer radical generator, polymer compounds having an active carbonyl group on the side chain and the like can be used. Examples of the polymer compounds having an active carbonyl group are disclosed in paragraphs [0012] to [0030] of JP-A No. 9-77891 and in paragraphs [0020] to [0073] of JP-A No. 10-45927. Among the base materials containing the polymer radical generator, those containing a polymer radical generator having a radical generating moiety on the side chain correspond to the base material (b).

A content amount of the radical generator may be decided by considering a base material type, a desirable production amount of graft polymer or the like, and it is generally preferably in the range of 0.1 to 40% by mass in a case of low-molecular weight radical generator, and 1.0 to 50% by mass in a case of polymer radical generator.

The base material having a radical generator directly chemically bonded thereto or the base material coated with a layer containing a radical-polymerizable unsaturated compound is coated may contain a sensitizer in addition to the radical generator in order to increase sensitivity.

The sensitizer becomes to an excited state by application of active energy ray, and it is possible to promote generation of useful groups such as a radical by interaction (for example, energy transfer, electron transfer or the like) with the radical generator.

The sensitizer which can be used in the invention is not particularly limited. The sensitizer can be appropriately selected according to the exposure wavelength from generally known sensitizers.

Specific examples thereof include generally known polynuclear aromatic compounds (for example, pyrene, perylene, triphenylene), xanthenes (for example, fluorescein, eosin, erythrosine, rhodamine B, rose Bengal), cyanines (for example, indocarbocyanine, thiacarbocyanine, oxacarbocyanine), merocyanines (for example, merocyanine, carbomerocyanine), thiazines (for example, thionine, methylene blue, toluidine blue), acridines (for example, acridine orange, chloroflavin, acriflavin), anthraquinones (for example, anthraquinone), squaliums (for example, squalium), acridones (for example, acridone, chloroacridone, N-methylacridone, N-butylacridone, N-butyl-chloroacridone or the like), and coumarins (for example, 3-(2-benzofuroyl)-7-diethylaminocoumarin, 3-(2-benzofuroyl)-7-(1-pyrrolidinyl)coumarin, 3-benzoyl-7-diethylaminocoumarin, 3-(2-methoxybenzoyl)-7-diethylaminocoumarin, 3-(4-dimethylaminobenzoyl)-7-diethylaminocoumarin, 3,3′-carbonylbis(5,7-di-n-propoxycoumarin), 3,3′-carbonylbis(7-diethylaminocoumarin), 3-benzoyl-7-methoxycoumarin, 3-(2-furoyl)-7-diethylaminocoumarin, 3-(4-diethylaminocinnamoyl)-7-diethylaminocoumarin, 7-methoxy-3-(3-pyridylcarbonyl)coumarin, 3-benzoyl-5,7-diproxycoumarin, and other coumarin compounds disclosed in each publication of JP-A Nos. 5-19475, 7-271028, 2002-363206, 2002-363207, 2002-363208, 2002-363209 or the like).

Examples of the combination of a photo-polymerization initiator and a sensitizer include electron transfer type initiator series disclosed in JP-A No. 2001-305734 [(1) an electron donating type initiator and a sensitizing dye, (2) an electron accepting type initiator and a sensitizing dye, (3) an electron donating type initiator, a sensitizing dye and an electron accepting type initiator (ternary initiating series)].

Preferable examples of the combination of a photo-polymerization initiator and a sensitizer include the combination of a triazine-based polymerization initiator (triazine polymerization initiator) and a sensitizer having maximum absorption at a wavelength of 360 nm to 700 nm.

Examples of other sensitizers include sensitizers having a basic nucleus, an acidic nucleus, and a fluorescent whitening agent. These will be described subsequently.

The sensitizer having a basic nucleus is not limited as long as it is a dye having basic nucleus in its molecule and can be appropriately selected according to an exposure wavelength (for example, visible light, optical laser, or the like).

In order to carry out laser light exposure at a wavelength of 360 to 700 nm in the invention, the maximum absorption wavelength of the sensitizer is preferably 700 nm or less, more preferably 500 nm or less, and still more preferably 450 nm or less.

Examples of the dyes having a basic nucleus include cyanine dyes, hemicyanine dyes, styryl dyes, and streptocyanine dyes. Examples of these dyes include bis-, tris- and polymer-type dyes thereof. Also, among them, cyanine dyes, hemicyanine dyes, and styryl dyes are preferable, and cyanine dyes and hemicyanine dyes are more preferable.

In a case where the dye having a basic nucleus is a cyanine dye, number of methine groups is preferably one, and if it is a hemicyanine dye, number of methine groups is preferably 5 or less. Also, if it is a styryl dye and has an aniline nuclear as a parent, number of methine chain is preferably 4 or less.

Basic nucleus is defined by “The theory of the Photographic Process”, fourth edition, edited by James, MacMillan, 1977, Chapter 8 “Sensitizing Dye and Desensitizing Dye”, and examples include those disclosed in U.S. Pat. Nos. 3,567,719, 3,575,869, 3,804,634, 3,837,862, 4,002,480, 4,925,777, and JP-A No. 3-167546.

Preferable examples of the basic nucleus include benzoxazole nucleus, benzothiazole nucleus, and indorenin nucleus.

Also, the basic nucleus is preferable to be an aromatic group substituted basic nucleus, or a basic nucleus in which three or more of rings are fused (tree or more ring-fused basic nucleus).

Fused number of basic nucleus are two in benzoxazole nucleus and three in naphtoxazole nucleus. Also, the fused number is two, even if the benzoxazole nucleus is substituted by phenyl. The three or more ring-fused basic nucleus may be any polycyclic-fused heterocyclic basic nucleus in which three or more rings are fused, and is preferably tricyclic-fused heterocycle or tetracyclic-fused heterocycle.

Examples of the tricyclic-fused heterocycle include naphtho[2,3-d]oxazole, naphtho[1,2-d]oxazole, naphtho[2,1-d]oxazole, naphtho[2,3-d]thiazole, naphtho[1,2-d]thiazole, naphtho[2,1-d]thiazole, naphtho[2,3-d]imidazole, naphtho[1,2-d]imidazole, naphtho[2,1-d]imidazole, naphtho[2,3-d]selenazole, naphtho[1,2-d]selenazole, naphtho[2,1-d]selenazole, indolo[5,6-d]oxazole, indolo[6,5-d]oxazole, indolo[2,3-d]oxazole, indolo[5,6-d]thiazole, indolo[6,5-d]thiazole, indolo[2,3-d]thiazole, benzofuro[5,6-d]oxazole, benzofuro[6,5-d]oxazole, benzofuro[2,3-d]oxazole, benzofuro[5,6-d]thiazole, benzofuro[6,5-d]thiazole, benzofuro[2,3-d]thiazole, benzothieno[5,6-d]oxazole, benzothieno[6,5-d]oxazole, and benzothieno[2,3-d]oxazole.

Examples of the tetracyclic-fused heterocycle include anthra[2,3-d]oxazole, anthra[1,2-d]oxazole, anthra[2,1-d]oxazole, anthra[2,3-d]thiazole, anthra[1,2-d]thiazole, phenanthro[2,1-d]thiazole, phenanthro[2,3-d]imidazole, anthrax[1,2-d]imidazole, anthra[2,1-d]imidazole, anthra[2,3-d]selenazole, phenanthro[1,2-d]selenazole, phenanthro[2,1-d]selenazole, carbazolo[2,3-d]oxazole, carbazolo[3,2-d]oxazole, dibenzofuro[2,3-d]oxazole, dibenzofuro[3,2-d]oxazole, carbazolo[2,3-d]thiazole, carbazolo[3,2-d]thiazole, dibenzofuro[2,3-d]thiazole, dibenzofuro[3,2-d]thiazole, benzofuro[5,6-d]oxazole, dibenzothieno[2,3-d]oxazole, dibenzothieno[3,2-d]oxazole, tetrahydrocarbazolo[6,7-d]oxazole, tetrahydrocarbazolo[7,6-d]oxazole, dibenzothieno[2,3-d]thiazole, dibenzothieno[3,2-d]thiazole, and tetrahydrocarbazolo[6,7-d]thiazole.

More preferable examples of the three or more of ring-fused basic nucleus include naphtho[2,3-d]oxazole, naphtho[1,2-d]oxazole, naphtho[2,1-d]oxazole, naphtho[2,3-d]thiazole, naphtho[1,2-d]thiazole, naphtho[2,1-d]thiazole, indolo[5,6-d]oxazole, indolo[6,5-d]oxazole, indolo[2,3-d]oxazole, indolo[5,6-d]thiazole, indolo[2,3-d]thiazole, benzofuro[5,6-d]oxazole, benzofuro[6,5-d]oxazole, benzofuro[2,3-d]oxazole, benzofuro[5,6-d]thiazole, benzofuro[2,3-d]thiazole, benzothieno[5,6-d]oxazole, anthra[2,3-d]oxazole, anthra[1,2-d]oxazole, anthra[2,3-d]thiazole, anthra[1,2-d]thiazole, carbazolo[2,3-d]oxazole, carbazolo[3,2-d]oxazole, dibenzofuro[2,3-d]oxazole, dibenzofuro[3,2-d]oxazole, carbazolo[2,3-d]thiazole, carbazolo[3,2-d]thiazole, dibenzofuro[2,3-d]thiazole, dibenzofuro[3,2-d]thiazole, dibenzothieno[2,3-d]oxazole, and dibenzothiano[3,2-d]oxazole, and preferable examples include naphtho[2,3-d]oxazole, naphtho[1,2-d]oxazole, naphtho[2,3-d]thiazole, indolo[5,6-d]oxazole, indolo[6,5-d]oxazole, indolo[5,6-d]thiazole, benzofuro[5,6-d]oxazole, benzofuro[5,6-d]thiazole, benzofuro[2,3-d]thiazole, benzothieno[5,6-d]oxazole, carbazolo[2,3-d]oxazole, carbazolo[3,2-d]oxazole, dibenzofuro[2,3-d]oxazole, dibenzofuro[3,2-d]oxazole, carbazolo[2,3-d]thiazole, carbazolo[3,2-d]thiazole, dibenzofuro[2,3-d]thiazole, dibenzofuro[3,2-d]thiazole, dibenzothieno[2,3-d]oxazole, and dibenzothieno[3,2-d]oxazole.

Examples of the basic nucleus include the following basic heterocycles.

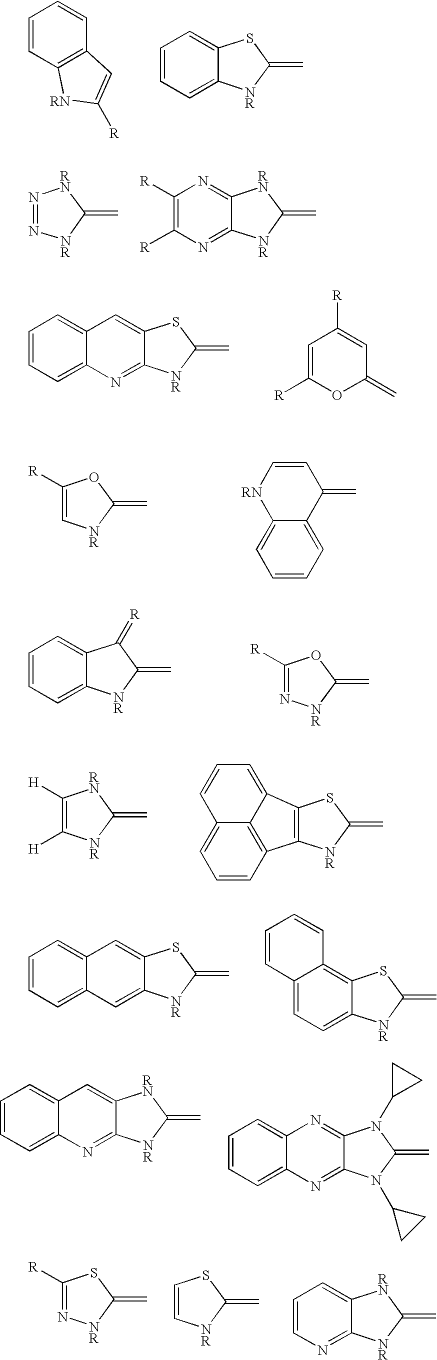

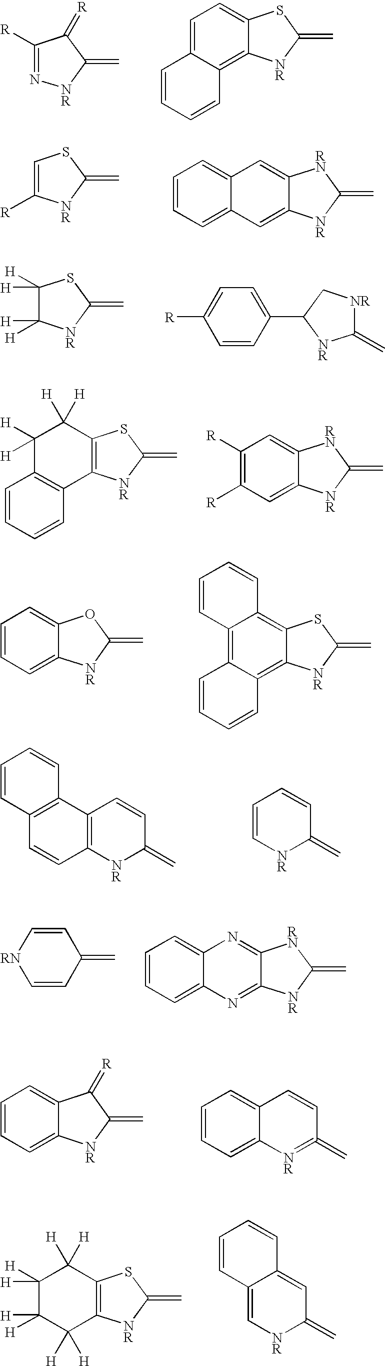

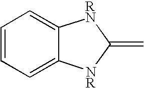

In the above formulae, R represents a hydrogen atom, an aliphatic group or an aromatic group.

Next, the sensitizer having an acidic nucleus will be described. The sensitizer having an acidic nucleus is not particularly limited as long as it is a dye having an acidic nucleus, and it can be appropriately selected according to an exposure wavelength.

Specific examples include merocyanine dyes, trinuclear merocyanine dyes, tetranuclear merocyanine dyes, rhodacyanine dyes, and oxonol dyes, and more preferable examples among them include merocyanine dyes and rhodacyanine dyes, and still more preferable examples include merocyanine dyes.

The acidic nucleus is defined by “The theory of the Photographic Process”, fourth edition, edited by James, MacMillan, 1977, Chapter 8 “Sensitizing Dye and Desensitizing Dye”, and examples include those disclosed in U.S. Pat. Nos. 3,567,719, 3,575,869, 3,804,634, 3,837,862, 4,002,480, 4,925,777, and JP-A No. 3-167546.

When the acidic nucleus is acyclic, a methine-bond terminal is preferably a group of an active methylene compound or the like, such as a ketone group or the like which is substituted by malononitrile, alkanesulfonylacetonitrile, cyanomethylbenzofuranylketone, cyanomethylphenylketone, malonic ester or acylaminomethyl.

When the atomic group required for forming the acidic nucleus is cyclic, it is preferable to form a 5- or 6-membered nitrogen containing heterocycle formed by carbon, nitrogen, and chalcogen (typically, oxygen, sulfur, selenium, and tellurium) atoms, and examples of the nitrogen containing heterocycle include 2-pyrazoline-5-one, pyrazolidine-3,5-dione, imidazoline-5-one, hydantoin, 2-thiohydantoin, 4-thiohydantoin, 2-iminooxazolidine-4-one, 2-oxazoline-5-one, 2-thiooxazoline-2,4-dione, isoxazoline-5-one, 2-thiazoline-4-one, thiazoline-4-one, thiazolidine-2,4-dione, rhodanine, thiazolidine-2,4-dithione, iso-rhodanine, indan-1,3-dione, thiophene-3-one, thiophene-3-one-1,1-dioxide, indoline-2-one, indoline-3-one, 2-oxoindazolinium, 3-oxoindazolinium, 5,7-dioxo-6,7-dihydrothiazolo[3,2-a]pyrimidine, cyclohexane-1,3-dione, 3,4-dihydroisoquinoline-4-one, 1,3-dioxane-4,6-dione, barbituric acid, 2-thiobarbituric acid, chroman-2,4-dione, indazoline-2-one, pyrido[1,2-a]pyrimidine-1,3-dione, pyrazolo[1,5-b]quinazolone, pyrazolo[1,5-a]benzoimidazole, pyrazolopyridine, 1,2,3,4-tetrahydroquinoline-2,4-dione, 3-oxo-2,3-dihydrobenzo[d]thiophene-1,1-dioxide, and 3-dicyanomethine-2,3-dihydrobenzo[d]thiophene-1,1-dioxide.

Examples of the acidic nucleus include the following acidic heterocycles.

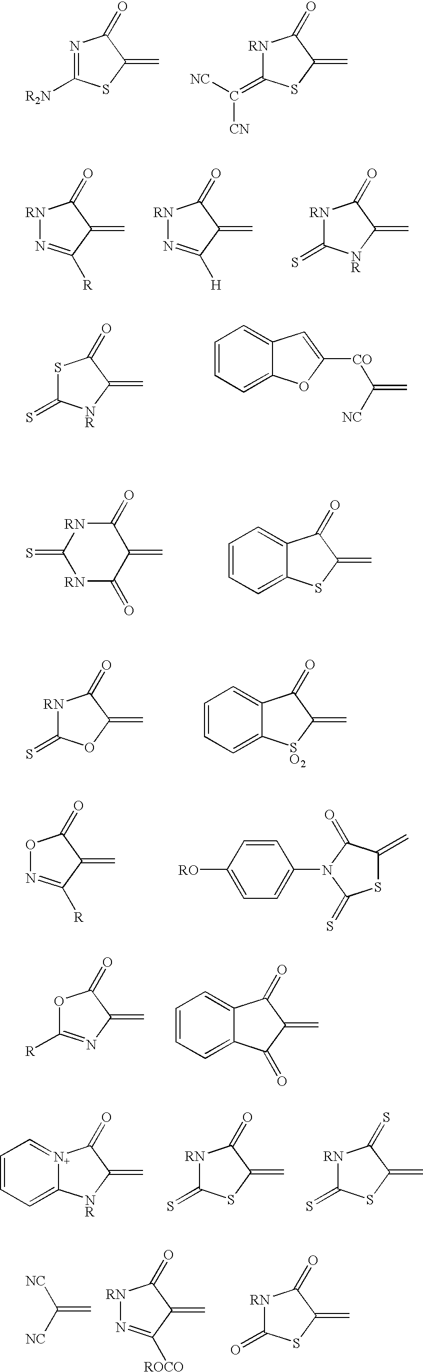

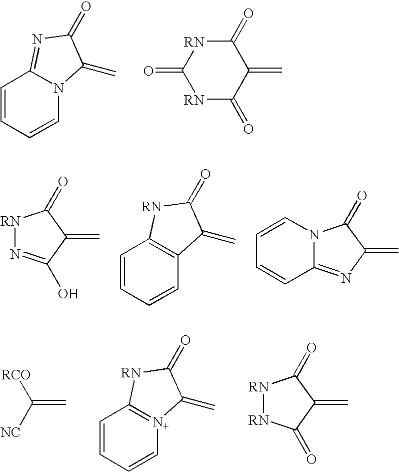

In the above formulae, R represents a hydrogen atom, an aliphatic group or an aromatic group.

Next, the sensitizer having a fluorescent brightening agent will be described.

The fluorescent brightening agent known as a “fluorescent whitening agent” is capable of absorbing a light having ultraviolet to short-wavelength visible light of around 300 to 450 nm wavelength and it is a non-colored or light-colored compound capable of emitting fluorescence having a wavelength of around 400 to 500 nm. Physical principal and chemical property of the fluorescent brightening agent are disclosed in “Ullmann's Encyclopedia of Industrial Chemistry” six^{th} edition, Electronic Release, Wiley-VCH 1998. Basically, an appropriate fluorescent brightening agent contains a π-electron system formed by containing a carbocyclic or heterocyclic nucleus.

A sensitizer of this type is not particularly limited as long as it is a fluorescent brightening agent, and can be appropriately selected according to the light exposure method (for example, visible light or ultraviolet radiation, optical laser or the like).

As the fluorescent brightening agent, a compound having a nonionic nucleus is preferred. Preferable examples of the nonionic nucleus include at least one type selected from nuclei of a stilbene nucleus, a distyrylbenzene nucleus, a distyrylbiphenyl nucleus, and a divinylstilbene nucleus.

The compound having a nonionic nucleus is not particularly limited and can be appropriately selected according to a purpose, and examples include pyrazolines, triazines, stilbenes, distyrylbenzenes, distyrylbiphenyls, divinylstilbenes, triazinylaminostilbenes, stilbenzyltriazoles, stilbenzylnaphthotriazoles, bis-triazolestilbenes, benzoxazoles, bisphenylbenzoxazoles, stilbenzylbenzoxazoles, bis-benzoxazoles, furans, benzofurans, bis-benzimidazoles, diphenylpyrazolines, diphenyloxadiazoles, naphthalimidos, xanthenes, carbostyrils, pyrenes, and 1,3,5-triazinyl-derivatives. Preferable examples among them include compounds having at least one type selected from a styryl group, a benzoxazolyl, and a benzothiazolyl group, and more preferable examples include distyrylbenzenes, distyrylbiphenyls, and bisbenzoxazoles and bisbenzothiazoles which are linked with a divalent linking group formed from ethenyl, aromatic ring, or heterocyclic group.

The fluorescent brightening agent may have a substituent. Examples of the substituent include an aliphatic group, an aromatic group, a heterocyclic group, a carboxyl group, a sulfo group, a cyano group, a halogen atom (for example, a fluorine atom, a chlorine atom, a bromine atom), a hydroxyl group, an alkoxycarbonyl group having 30 or less carbon atoms (for example, a methoxycarbonyl group, an ethoxycarbonayl group, a benzyloxycarbonyl group), an alkylsulfonylaminocarbonyl group having 30 or less carbon atoms, an arylsulfonylaminocarbonyl group, an alkylsulfonyl group, an arylsulfonyl group, an acylaminosulfonyl group having 30 or less carbon atoms, an alkoxy group having 30 or less carbon atoms (for example, a methoxy group, an ethoxy group, a benzyloxy group, a phenoxyethoxy group, a phenethyloxy group or the like), an alkylthio group having 30 or less carbon atoms (for example, a methylthio group, an ethylthio group, a methylthioethylthioethyl group or the like), an aryloxy group having 30 or less carbon atoms (for example, a phenoxy group, a p-tolyloxy group, an 1-naphthoxy group, a 2-naphthoxy group or the like), a nitro group, an alkyl group having 30 or less carbon atoms, an alkoxycarbonyloxy group, an aryloxycarbonyloxy group, an acyloxy group having 30 or less carbon atoms (for example, an acetyloxy group, a propynyloxy group or the like), an acyl group having 30 or less carbon atoms (for example, an acetyl group, a propionyl group, a benzoyl group or the like), a carbamoyl group (for example, a carbamoyl group, N,N-dimethylcarbamoyl group, a morpholinocarbonyl group, a piperidinocarbonyl group or the like), a sulfamoyl group (for example, a sulfamoyl group, N,N-dimethylsulfamoyl group, a morpholinosulfonyl group, a piperidinosulfonyl group or the like), an aryl group having 30 or less carbon atoms (for example, a phenyl group, a 4-chlorophenyl group, a 4-methylphenyl group, an α-naphthyl group or the like), a substituted amino group (for example, an amino group, an alkylamino group, a dialkylamino group, an arylamino group, a diarylamino group, an acylamino group or the like), a substituted ureido group, and a substituted phosphono group.

Typical examples of respective fluorescent brightening agent described above are disclosed in “Dye Handbook”, edited by Ohkawara, Kodansha, page 84 to 145 and 432 to 439.

The triazines are not particularly limited and can be appropriately selected according to a purpose, and examples include ethylenebismelamine, propylene-1,3-bismelamine, N,N′-dicyclohexylethylenebismelamine, N,N′-dimethylethylenebismelamine, N,N-bis[4,6-di-(dimethylamino)-1,3,5-triazinyl]ethylenediamine, N,N′-bis(4,6-dipiperidino-1,3,5-triazinyl)ethylenediamine, and N,N′-bis[4,6-di-(dimethylamino)-1,3,5-triazinyl]-N,N′-dimethylethylenediamine. Typical examples of fluorescent brightening agent are shown in the following formulae (1) to (7).

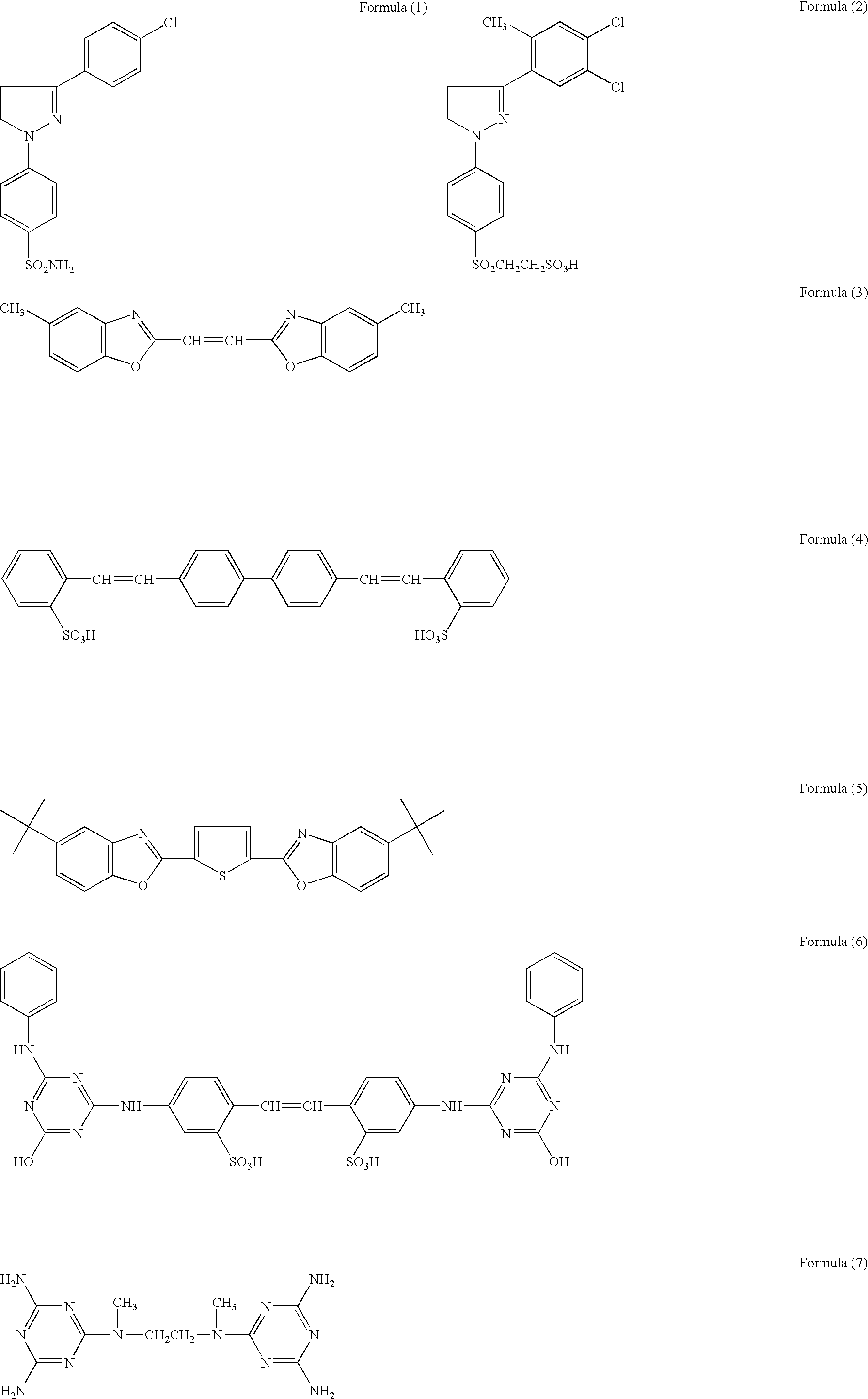

Those sensitizers are preferable to be contained in an approximate amount of 5 to 200% by mass with respect to a radical generator.

A base material (c) having a coated layer having a cross-linked structure formed therein, wherein the coated layer is formed by coating a support surface with a coating solution containing a cross-linking agent and a polymer compound including a radical-generating moiety on a side chain, and drying the coating solution will be described.

In the two embodiments previously described, a radical generator is contained in a base material itself. However it is also possible to form a “base material capable of generating radicals by exposure” by forming a layer having radical generating ability on a support surface, and examples of such method include a method using (c) a base material having a coated layer having a cross-linked structure formed therein, wherein the coated layer is formed by coating a support surface with a coating solution containing a cross-linking agent and a polymer compound including a radical-generating moiety on a side chain, and drying the coating solution.

In the embodiment (c), “a base material capable of generating radicals by exposure” is obtained by forming a polymerization initiating layer on a support, wherein the polymerization initiating layer is formed by fixing a polymer having a functional group having an ability of initiating polymerization on a side chain and a cross-linking group by a cross-linking reaction.

Among these, the aforementioned embodiment using a “solid formed by bonding a compound on a surface wherein the compound has a polymerization initiating moiety capable of initiating radical polymerization by photocleavage and a base material bonding moiety, as a solid capable of generating radicals by application of energy” is more preferable.

(Polymerizable Compound)

Next, polymerizable compounds to be used in the invention will be described.

In the invention, it possible to use monomer, macromonomoer, or polymer compounds having polymerizable groups as a polymerizable compound to be used for a graft polymer production. Any of those generally known polymerizable compounds can be used.

Among them, a polymerizable compound having a functional group capable of adsorbing a functional material, other than polymerizable groups such as unsaturated double bonds or the like, is preferable as a particularly useful polymerizable compound in the invention, and for a method of forming a conductive pattern to be described later, in the produced graft polymer, it is preferable to use a polymerizable compound having a functional group capable of forming a direct interaction with conductive materials and a functional group capable of forming a interaction with materials (for example, plating catalyst or the like) to be used for effectively maintaining a conductive material, so as to effectively and easily maintain a conductive material at a high density.

Hereinafter, the functional groups capable of forming a direct interaction with conductive materials and the functional groups capable of forming an interaction with materials to be used for effectively maintaining a conductive material, which are favorably used in a conductive pattern formation method, will be described as interactive groups on the whole.

Examples of the interactive groups include a polar group. Preferable examples of the polar group include a hydrophilic group and specific examples include functional groups having a positive charge such as ammonium and phosphonium, functional groups having a negative charge such as a sulfonic acid group, a carboxyl group, a phosphoric group, and a phosphonic group, and other nonionic groups such as a hydroxyl group, an amido group, a sulfonamide group, an alkoxy group, and a cyano group.

Hereinafter, polymerizable compounds having an interactive group which are to be used favorably for a graft polymer production process will be specifically described.

Examples of the monomers as the polymerizable compounds having an interactive group to be used in the invention include (meta) acrylic acid and alkali metal salt and amine salt thereof, itaconic acid and alkali metal salt and amine salt thereof, styrenesulfonic acid and alkali metal salt and amine salt thereof, 2-sulfoethyl(meta)acrylate and alkali metal salt and amine salt thereof, 2-acrylamide-2-methylpropanesulfonic acid and alkali metal salt and amine salt thereof, acid phosphoxypolyoxyethyleneglycolmono(meta)acrylate or alkali metal salt or amine salt thereof, polyoxyethylene glycolmono(meta)acrylate, 2-hydroxyethyl(meta)acrylate, (meta)acrylamide, N-monomethylol(meta)acrylamide, N-dimethylol(meta)acrylamide, allylamine or halogenated hydroacid salt thereof, N-vinylpyrrolidone, vinylimidazole, vinylpyridine, vinylthiophene, styrene, and (meta)acrylicester containing an alkyl group having 1 to 24 carbon atoms such as ethyl(meta)acrylicester, and n-butyl(meta)acrylicester.

The macromonomer as the polymerizable compound having an interactive group which are to be used in the invention can be prepared by a well known method with use of the monomer. Example of methods for macromonomer preparation to be used in the embodiment is disclosed in “Chemistry and Industry of Macromonomer” edited by Yuya Yamashita, IPC Shuppankyoku, Chapter 2 (“Synthesis of Macromonomers”), Sep. 20, 1989.

A weight-average molecular weight of such macromonomer is preferably in the range of 500 to 500,000 and more preferably in the range of 1000 to 50,000.

The polymer compound as the polymerizable compound having an interactive group to be used in the invention is a polymer in which an interactive group and an ethylene addition polymerizable unsaturated group (polymerizable group) such as vinyl group, allyl group and (meta)acrylic group are introduced. The polymer has at least an ethylene addition polymerizable unsaturated group on a terminal or a side chain, and it is preferable to have an ethylene addition polymerizable unsaturated group on a side chain and it is more preferable to have an ethylene addition polymerizable unsaturated group on a terminal and a side chain.

A weight-average molecular weight of such polymer compounds is preferably in the range of 500 to 500,000 and more preferably in the range of 1000 to 50,000.

Examples of synthesizing methods of polymer compounds having an interactive group and a polymerizable group include i) a method of copolymerizing a monomer having an interactive group and a monomer having a polymerizable group, ii) a method of copolymerizing a monomer having an interactive group and a monomer having a polymerizable group precursor and then, introducing a double bond through processing with a base or the like, and iii) a method of introducing a polymerizable group by reacting a polymer having an interactive group and a monomer having a polymerizable group.

From a synthesizing adequacy point of view, preferable examples of the synthesizing methods are the methods of ii) copolymerizing a monomer having an interactive group and a monomer having a polymerizable group precursor and then, introducing a double bond through processing with a base or the like, and iii) introducing a polymerizable group by reacting a polymer having an interactive group and a monomer having a polymerizable group.

Examples of the monomers having an interactive group to be used in the synthesizing method of aforementioned i) and ii) include (meta)acrylic acid and alkali metal salt and amine salt thereof, and itaconic acid and alkali metal salt and amine salt thereof, and specific examples include 2-hydroxyethyl(meta)acrylate, (meta)acrylamide, N-monomethylol(meta)acrylamide, N-dimethylol(meta)acrylamide, allylamine and halogenated hydroacid thereof, 3-vinylpropionic acid and alkali metal salt and amine salt thereof, vinylsulfonic acid and alkali metal salt and amine salt thereof, 2-sulfoethyl(meta)acrylate, polyoxyethyleneglycolmono(meta)acrylate, 2-acrylamide-2-methylpropanesulfonic acid, acid phosphoxypolyoxyethyleneglycolmono(meta)acrylate, N-vinylpyrrolidone (structure shown as below), styrenesulfonic acid sodium, and vinylbenzoic acid. In general, monomers having a functional group such as a carboxyl group, a sulfonic acid group, a phosphoric acid group, an amino group or salts thereof, a hydroxy group, an amido group, a phosphine group, an imidazol group, a pyridine group or salts thereof, and an ether group can be used.

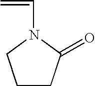

Examples of monomers having a polymerizable group which can be copolymerized with a monomer having the interactive group include allyl(meta)acrylate and 2-allyloxyethylmethacrylate.

Also, examples of monomers having a polymerizable group precursor to be used in the aforementioned synthesizing method ii) include 2-(3-chloro-1-oxopropoxy)ethylmethacrylate and compounds (i-1 to i-60) disclosed in JP-A No. 2003-335814 and preferable example among them is a compound (i-1) as shown below.

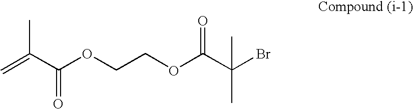

In addition, examples of the monomer having a polymerizable group include (meta)acrylic acid, glycidyl(meta)acrylate, allylglycidylether, and 2-isocyanatoethyl(meta)acrylate, wherein the monomer is used for introducing a polymerizable group by a reaction of functional groups such as a carboxyl group, an amino group, or salts of them, a hydroxy group, and an epoxy group, which are contained in the polymer having an interactive group to be used in the aforementioned synthesizing method iii).

As for the aforementioned synthesizing method of ii) copolymerizing a monomer having an interactive group and a monomer having a polymerizable group precursor and then, introducing a double bond through processing with a base or the like, a method disclosed in JP-A No. 2003-335814 for example can be used.

A solvent for a liquid composition containing the polymerizable compound is not particularly limited as long as it can dissolve or disperse the polymerizable compounds that is the main component, and it is preferable to be an aqueous solvent such as a water soluble solvent, and a surface active agent may be added further to the mixture or the solvent.

Examples of the usable solvents include an alcohol solvent such as methanol, ethanol, propanol, ethylene glycol, glycerin, and propyleneglycol monomethyl ether, acids such as acetic acid, ketone solvents such as acetone and cyclohexanone, and an amide solvents such as formamide and dimethylacetoamide.

Also, the surface active agent which can be added when required can be anything if it can be dissolved in a solvent, and examples of the surface active agent include anionic surface active agents such as sodium n-dodecylbenzenesulfonate, cationic surface active agents such as n-dodecyltrimethylammoniumchloride, and nonionic surface active agents such as polyoxyethylene nonylphenolether (an example of a commercial product thereof is, EMULGEN 910, manufactured by Kao Corporation), polyoxyethylenesorbitan monolaurate (an example of a commercial product thereof is TWEEN 20), and polyoxyethylene lauryl ether.

When using a method of forming a coating layer by coating a substrate surface with a liquid composition containing a polymerizable compound, from a point of obtaining a sufficient coating layer, the coating amount in terms of solid content is preferably in the range of 0.1 to 10 g/m² and more preferably in the range of 0.5 to 5 g/m².

The film thickness of a film (graft polymer film) formed from an obtained graft polymer is preferably in the range of 0.1 to 2.0 g/m², more preferably in the range of 0.3 to 1.0 g/m², and still more preferably in the range of 0.5 to 1.0 g/m².

(Exposure)

In the process, pattern exposure for forming graft polymer, pattern exposure for deactivating a polymerization initiating ability, and further, entire surface exposure for forming graft polymer, and entire surface exposure using a mask pattern are exposures generating a polymerization initiating ability or capable of generating a cleavage at a polymerization initiating moiety (Y) by working on a compound having an aforementioned ability to generate radicals and on a sensitizer, and specifically laser light of wavelength 360 to 700 nm is used.

Examples of light source include a scanning exposure of using cathode rays (CRT). Various illuminators showing a light emission at a spectrum region according to necessity may be used in a cathode ray tube which is to be used in an imagewise exposure. For example, any one of red-colored illuminator, green-colored illuminator, and blue-colored illuminator may be used, or two or more thereof may be used in mixture. The spectral region is not limited to the aforementioned red, green and blue colors and a fluorescent material of emitting yellow, orange, and violet colors can also be used.

Also, in the process, pattern exposure can be performed by using various laser beams. Preferable examples for the pattern exposure include use of a scanning exposure system of using a monochromatic high-density light such as a laser including a gas laser, a light-emitting diode, and a semiconductor laser; and a second harmonic generation (SHG) constructed with a semiconductor laser or a solid-state laser in which a semiconductor laser is used for excitation light source, together with a nonlinear optical crystal. Additionally, KrF Excimer laser, ArF Excimer laser, F2 laser or the like also can be used.

A pattern resolution formed by the invention is dependent on exposure conditions. That is, in pattern exposures for forming graft polymer or deactivating polymerization initiating ability, a high-definition pattern according to an exposure is formed by applying a high-definition exposure. Examples of the exposure method for forming high-definition pattern include a light beam scanning exposure using optic systems and an exposure using mask, and the exposure method may be selected in accordance with a desirable pattern resolution.

Specific examples of a high-definition pattern exposure include stepper exposures such as i-ray stepper, g-ray stepper, KrF stepper, and ArF stepper.

A base material in which a graft polymer is formed as described above is immersed or washed with solvent, and purified by eliminating remained homopolymer. Specific examples include washing with water or acetone and drying. From a homopolymer removal point of view, a method of using an ultrasonic wave may be used. In the purified base material, all the remained homopolymer in the surface thereof are completely removed and only the patterned graft polymer strongly bonded to the base maberial remains on the surface.

In this manner, a graft pattern material in which a graft polymer is directly bonded to a base material patternwise is obtained.

[Conductive Pattern Forming Method]

In the conductive pattern forming method of the second aspect in the invention, a process of imparting conductivity to a graft polymer formation region of the graft pattern material obtained in the manner previously described is carried out by, for example, adhering a conductive material to the graft polymer formation region.

<Conductivity Imparting Process (Conductive Material Adhesion Process)>

In the process, a conductivity development layer in pattern form is formed by imparting conductivity to a graft polymer formed patternwise. Specific examples of the methods include the following four embodiments and these embodiments may be carried out by a method of adhering a conductive material to a graft polymer, a method of adhering a conductive material by adhering a conductive material precursor to a graft polymer and forming a conductive material, or the like.

A first embodiment is a method for forming a conductive particle adsorption layer by making a conductive particle adsorb to an interactive group (ionic group) of the graft polymer.

A second embodiment is a method for forming a plating film by making an electroless plating catalyst or a precursor thereof adsorb to an interactive group of the graft polymer and then by performing an electroless plating.

A third embodiment is a method for forming a metal particles dispersion film by making a metal ion or metal salt adsorb to an interactive group of the graft polymer and then by reducing the metal ion or metal ion in a metal salt.

A fourth embodiment is a method for forming a conductive polymer layer by first making a conductive monomer adsorb to an interactive group of graft polymer and then by generating a polymerization reaction thereto.

For a conductive layer formation, from an electrical characteristic such as conductivity point of view, it is preferable to apply electroless plating catalyst or precursor thereof to a graft polymer formation region and carry out electroless plating, and further it is preferable to carry out electroless plating by a use of an electroless plating bath containing trialkanolamine or specifically triethanolamine.

Hereinafter, the aforementioned embodiments 1 to 4 will be described.

### FIRST EMBODIMENT

### Conductive Particle Adsorption Layer Formation

The first embodiment of the conductive material adhesion process is a method for forming a conductive particle adsorption layer by ionically making a conductive particle to be described later adsorb to an interactive group contained in the aforementioned graft polymer, more preferably to an ionic group, in accordance with a polarity thereof. In this manner, a conductive layer made of a conductive particle absorption layer is formed.

Herein this embodiment has an advantage of having excellent adhesion property of the base material and the conductive particle adsorption layer together with developing a sufficient conductivity, since the conductive particles form an interaction with the interactive group of the graft polymer and to be fixed in a monomolecular film state or multilayer state.

The conductive particles which may be used in the first embodiment is not particularly limited as long as they have conductivity, and any particles of generally known conductive materials may be selected and used. Preferable examples include metal particles such as Au, Ag, Pt, Cu, Rh, Pd, Al and Cr; oxide semiconductor particles such as In₂O₃, SnO₂, ZnO, Cdo, TiO₂, CdIn₂O₄, Cd₂SnO₂, Zn₂SnO₄, and In₂O₃—ZnO; particles using materials in which corresponding impurities thereof are doped; spinel form compound particles such as MgInO and CaGaO; conductive nitride particles such as TiN, ZrN, and HfN; conductive boride particles such as LaB; and organic material particles such as conductive polymer particles.

Those conductive particles can be used alone or in combination of plural kinds as necessary. Also plural materials previously mixed can be used to obtain a desirable conductivity.

—Relationship Between a Polarity of Ionic Group (Interactive Group) of Graft Polymer and a Conductive Particle—

When the graft polymer obtained in the invention has an anionic interactive group such as a carboxyl group, a sulfonic group, or a phosphonic group, the interactive group of the graft polymer happens to selectively have a negative charge, and conductive particles having a positive charge (cationic) can be adsorbed in here.

Examples of the cationic conductive particles includes metal (oxide) particles having a positive charge. Particles having a positive charge at high-density on a surface can be prepared by, for example, the methods of Toru Yonezawa et al. That is, the methods disclosed in T. Yonezawa, Chemistry letters., 1999, page 1061, T. Yonezawa, Langumuir 2000, vol 16, 5218, and T. Yonezawa, Polymer preprints Japan, Vol. 49, 2911 (2000). Yonezawara et al. are proposing that metal particle surface chemically modified with a functional group having a positive charge at high-density can be formed by using a metal-sulfur binding.

Alternatively, when the obtained graft polymer has a cationic interactive group such as an ammonium group which is disclosed in JP-A No. 10-296895, the interactive group of graft polymer becomes to selectively have a positive charge and conductive particles having a negative charge can be adsorbed in here.

Examples of the negatively charged conductive particles include silver particle or gold obtained by citric acid reduction.

The particle size of conductive particles to be used in the invention considering an adsorptive property to an interactive group and conductivity development is preferably in the range of 0.1 to 1000 nm, and more preferably in the range of 1 to 100 nm.

Examples of a method adsorbing conductive particles to an interactive group of graft polymer include a method of coating a graft polymer formation region with a solution in which conductive particles having a charge on a surface is dissolved or dispersed; and a method of immersing a substrate on which graft polymer is formed into the solution or the dispersion.

In both of the case of coating and immersing, time of contacting a solution or dispersion with graft polymer formation surface is preferably about 10 second to 24 hours and more preferably about 1 to 180 minutes so as to introduce conductive particles to an interactive group (ionic group) by ionic bonding by first supplying an excessive amount of conductive particles.

Also, from a resistance and conductivity assurance point of view, the conductive particles are preferable to be bonded in a maximum amount by being adsorbed to an interactive group of graft polymer, and in this case, it is preferable to have a dispersion concentration of dispersion in the range of about 0.001 to 20% by mass.

Also, in the first embodiment of conductive material adhesion process, it is preferable to be carried out by adsorbing conductive particles to graft polymer and then heating the whole substrate. Adhesion between the conductive particles happens by heating and improves an adhesion between the conductive particles together with improvement in conductivity.

Herein, temperature of heat processing is preferably in the range of 50 to 500° C., more preferably 100 to 300° C., and still more preferably 150 to 300° C.

### SECOND EMBODIMENT

### Plating Film Formation

The second embodiment of conductive material adhesion process is a method for forming a plating film by adsorbing an electroless plating catalyst or a precursor thereof to an interactive group of graft polymer and then by performing electroless plating to an interactive group contained in the graft polymer. In this manner, a conductivity development layer made of a plating film is formed.

Since the plating film is formed by electroless plating to a catalyst or a precursor adsorbed to an interactive group of graft polymer, the plating film and the graft polymer are strongly bonded and as a result, advantages to have excellent adhesion of substrate and a plating film, together with an adjustable conductivity in accordance with plating conditions can be obtained.

Firstly, method of applying an electroless plating catalyst or a precursor thereof in the second aspect will be described.

The electroless plating catalyst to be used in the embodiment is mainly a metal having a 0 valency such as Pd, Ag, Cu, Ni, Al, Fe, and Co. In the invention, particularly the metals of Pd and Ag are preferred as they are easy to handle and high in catalytic ability. As a method for setting a 0 valency metal to an interactive region, for example, a method of providing a metal colloid in which charge is adjusted to make it interact with an interactive group of graft polymer, to the graft polymer surface can be used. Generally, metal colloid can be prepared by reducing a metal ion in a solution where a surface active agent having a charge or a protective agent having a charge is present. Charge of the metal colloid can be adjusted by the surface active agent or the protective agent used in here, and the metal colloid (electroless plating catalyst) can be adhered to the graft polymer by interacting the charge adjusted metal colloid whose charge is adjusted with an interactive group of a graft polymer.

Electroless plating catalyst precursor to be used in the aspect can be used with no specific limitation as long as it can be an electroless plating catalyst by a chemical reaction. Mainly a metal ion of 0 valent metal used in the aforementioned electroless plating catalyst can be used. Metal ion, which is a precursor of an electroless plating catalyst, becomes to a 0 valent metal, which is an electroless plating catalyst, by a reduction reaction. The metal ion, which is a precursor of an electroless plating catalyst, may be converted to 0 valent metal by carrying out an extra reduction reaction after it is applied to a graft polymer formation region before immersing into an electroless plating bath so as to be an electroless plating catalyst, or may be converted to a metal (electroless plating catalyst) by a reducing agent in the electroless plating bath by immersing a precursor of an electroless plating catalyst as it is into the electroless plating bath.

The metal ion, which is the electroless plating precursor, is applied to a graft polymer in a metal salt state. The metal salt to be used is not particularly limited as long as it can be dissolved in an suitable solvent and it can be separated into metal ion and base (anion), and examples include M(NO₃)n, MCln, M_{2/n}(SO₄), and M_{3/n}(PO₄) (M represents an n valent metal atom). Aforementioned dissociated metal salt can be preferably used as a metal ion. Specific examples include Ag ion, Cu ion, Al ion, Ni ion, Co ion, Fe ion, and Pd ion, and Ag ion and Pd ion are particularly preferred from a catalytic ability point.

A method of applying a metal colloid which is the electroless plating catalyst, or a metal salt which is the electroless plating precursor, to a graft polymer may be a method including dispersing a metal colloid in an appropriate dispersion medium or dissolving a metal salt in an suitable solvent, and then either coating a graft polymer formation region with the solution or immersing a substrate in which a graft polymer is formed in the solution thereof. By contacting a solution containing a metal ion, metal ion can be adhered to an interactive group contained in a graft polymer by using an ion-ion interaction or a dipole-ion interaction, or the metal ion can be impregnated to an interactive region. In order to sufficiently perform an adhesion and an impregnation, concentration of metal ion in a solution to be contacted or concentration of metal salt is preferably in the range of 0.01 to 50% by mass, and more preferably in the range of 0.1 to 30% by mass. Also, contact time is preferably about 1 minute to 24 hours and more preferably about 5 minutes to 1 hour.

Next, electroless plating method in the second embodiment will be described.

An electroless plating film is formed by performing electroless plating to a substrate to which an electroless plating catalyst or a precursor are applied.

Electroless plating is an operation of depositing a metal by a chemical reaction with use of a solution in which metal ion desirable to be deposited as a plate is dissolved.

Electroless plating in the process can be carried out by water-washing a substrate to which an electroless plating catalyst is applied and removing the excessive electroless plating catalyst (metal), and then by immersing into an electroless plating bath. As an electroless plating bath to be used, generally known electroless plating bath can be used.

Also, in a case where a substrate to which an electroless plating catalyst precursor is adhered is immersed in an electroless plating bath in a state of electroless plating catalyst precursor adhered or impregnated to graft polymer, substrate is first washed with water and excessive precursor (metal salt or the like) is removed, and then immersed in an electroless plating bath. In this case, precursor reduction followed by electroless plating proceeds in an electroless plating bath. The electroless plating bath to be used can also be the generally known electroless plating bath as those described above.

In general, the composition of the electroless plating bath mainly contains 1. a metal ion for a plating use, 2. a reducing agent, and 3. an additive (stabilizer) for improving a metal ion stability. In the plating bath, generally known additives such as a stabilizer of plating bath may be contained in addition to the ones described above.

As metals to be used in the electroless plating bath, copper, tin, lead, nickel, gold, palladium, and rhodium are known, and among them, copper and gold are particularly preferred from the view point of conductivity.

Also, there are most appropriate reducing agent and additives according to the aforementioned metal.

For example, any copper electroless plating bath can be used with no specific limitation as long as copper salt can provide a copper ion. Examples include copper sulfate (CuSO₄), copper chloride (CuCl₂), copper nitrate (Cu(NO₃)₂), copper hydroxide (Cu(OH)₂), copper oxide (CuO), and cuprous chloride (CuCl). The amount of copper ion present in a bath is generally from 0.005 to 1 M and preferably from 0.01 to 0.07 M. Reducing agent is not particularly limited as long as it can reduce copper ion to metal copper, and preferable examples include formaldehyde and its derivatives, and polymer such as paraformaldehyde or its derivatives or precursors. Amount of reducing agent is in the range of 0.05 M or above, and preferably 0.05 to 0.3 M when converted to formaldehyde equivalent value.

Any pH regulator can be used with no specific limitation as long as it can modify pH, and a compound raising the pH value or a compound lowering the pH value can be appropriately selected and used according to its need. Specific examples of the pH regulator include NaOH, KOH, HCl, H₂SO₄, and HF.

The pH of an electroless plating bath is generally in the range of 12.0 to 13.4 (25° C.) and desirably 12.4 to 13.0 (25° C.). Examples of the additives include EDTA which is a stabilizer of copper ion, Rochelle salt, and trialkanolamine, and from the view of point of adhesion of a glass substrate and a plating film, trialkanolamine is preferred. The adding amount of these stabilizers are in the range of 1.2 to 30 times of copper ion and preferably 1.5 to 20 times. Also, the absolute amount of stabilizer present in solution is preferably in the range of 0.006 to 2.4 M and more preferably 0.012 to 1.6 M.

Examples of trialkanolamine which is used as a stabilizer include trimethanolamine, triethanolamine, triisopropanolamine, and tripropanolamine, and triethanolamine is particularly preferred from the view point of adhesion of a glass substrate and a plating film.

Also, examples of additive for improving a bath stability and plating film smoothness include polyethyleneglycol, potassium ferrocyanide, and bipyridine. Concentration of these additives present in the bath is preferably in the range of 0.001 to 1 M and more preferably 0.01 to 0.3 M.

A plating bath to be used for electroless plating of CoNiP includes cobalt sulfate and nickel sulfate as a metal salt, sodium hypophosphite as a reducing agent, sodium malonate, sodium malate, and sodium succinate as a complexing agent. A palladium electroless plating bath includes (Pd(NH₃)₄) Cl₂ as a metal ion, NH₃ and H₂NNH₂ as a reducing agent, and EDTA as a stabilizer. In these plating baths, components other than the aforementioned ones may also be included.

A film thickness of the electroless plating film obtained in the above manner can be controlled by metal salt or metal ion concentration of the plating bath, immersing time to the plating bath, or temperature of the plating bath, and the film thickness is preferably 0.5 μm or more, and more preferably 3 μm or more from the view point of conductivity. Also, immersing time to the plating bath is preferably in the range of about 1 minute to 3 hours and more preferably about 1 minute to 1 hour.

In the electroless plating film obtained in the mentioned manner, the sectional observation according to SEM confirms that electroless plating catalyst or fine particles of the plating metal are densely dispersed in the graft polymer film, and that relatively larger particles are deposited thereon. Since the interface is in a hybrid state of the graft polymer and the fine particles, although an average roughness (Rz) of the substrate surface is 3 μm or less, adhesion of a substrate (organic component) and an inorganic material (electroless plating catalyst or plating metal) is excellent.

In the second embodiment of the conductive material adhesion process, electroplating can be carried out after finishing the electroless plating. That is, the electroplating is carried out by using the electroless plating film which is obtained by the aforementioned electroless plating, as an electrode. In this manner, new plating film having a desirable thickness can be easily formed thereon by making the electroless plating film which is excellent in adhesion with substrate as a base. By adding this process, a conductive film having a thickness suitable for the object can be formed.

As the electroplating method in this embodiment, conventionally known method can be used. Examples of metal to be used for the electroplating include copper, chrome, lead, nickel, gold, silver, tin, and zinc, and from conductivity point of view, copper, gold and silver are preferred and copper is more preferred.

Film thickness of the plating film obtained by electroplating differs according to its need and it can be controlled by adjusting a concentration of metal included in a plating bath, an immersing time, or a current density. Herein, in a situation where surface conductive material obtained by the invention is used for making a printed-wiring board, plating film thickness is preferably 0.3 μm or above, and more preferably 3 μm or above from the view point of conductivity.

### THIRD EMBODIMENT

### Metal Particle Dispersed Film Formation

The third aspect of the conductive material adhesion process is a method for forming a metal particle dispersed film by ionically adsorbing a metal ion or a metal salt which will be described later to an interactive group contained in the aforementioned graft polymer, and more preferably to an ionic group, in accordance with a polarity thereof, and then depositing metal element by depositing the metal ion or the metal ion in metal salt. The metal particle dispersed film can be a metal thin film according to a deposition mode of the metal element. In this manner, a conductivity development layer made of a metal particle dispersed film can be formed.

Herein, since the deposited metal particles for forming the metal particle dispersed film form an interaction with the interactive group of graft polymer and adsorbed the interactive group, this embodiment has an advantage of having excellent adhesion of substrate and metal particle dispersed film together with generating a sufficient conductivity.

(Metal Ion and Metal Salt)

Next, metal ion and metal salt to be used in this embodiment will be described.

In this embodiment, the metal salt is not specifically limited as long as it can be dissolved in a suitable solvent to be applied to the graft polymer formation region and it can be separated into a metal ion and a base (negative ion). Examples include M(NO₃)ₙMClₙ, M_{2/n}(SO₄), M_{3/n}(PO₄) (M represents an n valency metal atom). The metal ion obtained by dissociating the aforementioned metal salt can be suitably used. Specific examples include Ag, Cu, Al, Ni, Co, Fe and Pd. Ag and Cu are particularly preferred among them.

The metal salt or the metal ion may be used alone or in combination of two or more if necessary. A plurality of materials may be also previously mixed so as to obtain the desired conductivity.

(Method for Applying a Metal Ion and a Metal Salt)

(1) In a case where graft polymer has an ionic group, the metal ion or the metal salt may be applied to the graft polymer by a method of adsorbing the metal ion to the ionic group thereof. In this case, aforementioned metal salt is dissolved in a suitable solvent and a graft polymer formation region may be coated with this solution containing the dissociated metal salt, or the base material in which the graft polymer is formed may be immersed in the solution thereof. The metal ion can be ionically adsorbed to the ionic group by contacting the solution containing the metal ion. It is preferable that the metal ion concentration of the solution contacted is in the range of 1 to 50% by mass, and more preferably 10 to 30% by mass from the view point of sufficient adsorption. The contact time is preferably about 10 seconds to 24 hours and more preferably about 1 minute to 180 minutes.

(2) In a case where the graft polymer has high affinity to the metal as polyvinyl pyrrolidone, the metal ion or the metal salt may be applied to the graft polymer by directly adhering the particles of above metal salt to the graft polymer, or by preparing a dispersion by using a suitable solvent in which the metal salt can be dispersed and coating the graft polymer formation region with the dispersion, or alternatively by immersing the base material in which the graft polymer is formed in the solution.

In a case where the graft polymer has a hydrophilic group as the interactive group, since the graft polymer film has a high water holding property, it is preferable to impregnate the graft polymer film with the dispersion in which the metal salt is dispersed by using the high water holding property. It is preferable that the metal salt concentration of the dispersion contacted is in the range of 1 to 50% by mass and more preferably 10 to 30% by mass from the view point of performing impregnation of the dispersion sufficiently. The contact time is preferably in the range of about 10 seconds to 24 hours, and more preferably about 1 minute to 180 minutes.

(3) In a case where the graft polymer has a hydrophilic group, the metal ion or the metal salts may be applied to the graft polymer by coating the graft polymer formation region with the dispersion in which the metal salt is dispersed or with the solution in which the metal salt is dissolved, or by immersing the base material in which the graft polymer is formed into the dispersion or the solution thereof.

In this method, the graft polymer film can be impregnated with the dispersion or the solution by using a high water holding property of the graft polymer film as described in the above manner. It is preferable that the metal ion concentration of dispersion contacted or metal salt concentration is within the range of 1 to 50% by mass, and more preferably 10 to 30% by mass from the view point of performing impregnation of the dispersion or the solution sufficiently. The contact time is preferably in the range of about 10 seconds to 24 hours, and more preferably about 1 minute to 180 minutes.

Especially, according to the method (3), desirable metal ion or metal salt can be applied despite characteristics of the interactive group contained in the graft polymer.

(Reducing Agent)

Subsequently, a reducing agent to be used for reducing metal salt or metal ion existing through adsorbing or immersing with the graft polymer (film) will be described.

The reducing agent to be used in the invention is not specifically limited as long as it reduces metal ion and has the physical properties for depositing metal element, and examples include hypophosphite, tetrahydroborate and hydrazine.

These reducing agents can be appropriately selected by the relationship between the metal salt and the metal ion to be used. For example, when silver nitrate aqueous solution or the like is used as a metal salt aqueous solution supplying the metal salt and the metal ion, sodium tetrahydroborate may be suitably used. When an aqueous solution of palladium dichloride is used, hydrazine may be suitably used.

Methods for adding the above reducing agent may be a method including processes of applying the metal ion or the metal salt to the surface of the base material in which the graft polymer is formed, washing the surface so as to remove excessive metal salt and metal ion, immersing the base material provided with the surface in water such as ion exchanged water, and adding the reducing agent thereto. The method for adding reducing agent may be a method including a step of directly coating or dropping a reducing agent aqueous solution having a predetermined concentration on the surface of the base material. It is preferable to use the reducing agent of an excessive amount of an equivalent or more to the metal ion, and more preferably 10 times equivalents or more.

Herein, relationship between the interactive group of the graft polymer and the metal ion or metal salt in the third embodiment will be described.

When the interactive group of the graft polymer has a polar group having a negative charge or an ionic group having an anionic property such as a carboxyl group, a sulfonic acid group or a phosphonic acid group, since the graft polymer film selectively becomes to have a negative charge, the metal ion having a positive charge is adsorbed thereon and the adsorbed metal ion is reduced so as to deposit the metal element.

Also, when the interactive group of the graft polymer is an ionic group of a cationic group such as an ammonium group disclosed in JP-A No. 10-296895, since the graft polymer film selectively becomes to have a positive charge, the metal ion does not adsorb in a form of as it is. Therefore, the metal element is deposited by impregnating the dispersion in which the metal salt is dispersed or the solution in which the metal salt is dissolved, to the graft polymer film by using a hydrophilicity possessed by the ionic group of the interactive group, and then by reducing the metal ion in the solution impregnated or the metal ion in the metal salt.

In the aforementioned manner, the metal particle dispersed film can be formed by the metal element deposition.

Although the existence of the metal element (metal particle) deposited in the metal particle dispersed film can be visually checked from the metal luster of the surface, the structure (form) can be checked by observing the surface using a transmission electron microscope or an AFM (atomic force microscope). The film thickness of the metal pattern can be easily measured by a conventional method, for example, by a method for observing a cutting plane using an electron microscope.

By observation of the deposited state of the metal element by use of the aforementioned microscopes, it is confirmed that the metal particles are densely dispersed in the graft polymer film. The size of the metal particles deposited is in a range of about 1 μm to 1 nm.

In the metal particle dispersed film, when the metal particles are densely dispersed and apparently formed a thin metal film, the metal particle dispersed film can be used as it is, but it is preferable to heat the metal particle dispersed film from a view point of maintaining an efficient conductivity.

The heating temperature of the heat treatment process is preferably 100° C. or more, more preferably 150° C. or more, and still more preferably about 200° C. The heating temperature is preferably 400° C. or less in consideration of the processing efficiency and the dimensional stability of the base material or the like. The heating time is preferably 10 minutes or more, and more preferably in the range of about 30 to 60 minutes. Although the operation mechanism due to the heat treatment is not clear, the conductivity is improved since the part of metal particles close to each other fuse mutually.

### FOURTH EMBODIMENT

### Conductive Polymer Layer Formation

The fourth embodiment of the conductive material adhesion process is a method for forming a conductive polymer layer by ionically adsorbing a conductive monomer which will be described later to an interactive group or more preferably to an ionic group of the aforementioned graft polymer, and then by directly emerging a polymerization reaction. The conductivity development layer made of the conductive polymer layer can be formed by this method.

Herein, since the conductive polymer layer is formed by polymerizing the conductive monomer ionically adsorbed with the interactive group of the graft polymer, it has an advantage of having excellent adhesion to the substrate and resistance together with a capability of controlling a film thickness or conductivity by adjusting the conditions of polymerization reaction such as a rate of supplying monomer.

The method for forming such conductive polymer layer is not specifically limited and it is preferable to use a method which will be described below from a view point of forming uniformly thin films.

Firstly, the substrate on which the graft polymer is formed is immersed in the solution containing a polymerization catalyst such as potassium persulfate iron sulfate(III) and a compound having a polymerization initiating ability, and the monomer which can form a conductive polymer, for example 3,4-ethylendioxythiophene or the like, is gradually dropped while the solution is being stirred. In this manner, the interactive group (ionic group) in the graft polymer in which the polymerization catalyst or the polymerization initiating ability are applied, and the monomer which can form the conductive polymer are strongly adsorbed by the interaction, and at the same time polymerization reaction of the monomers proceeds so as to form an extremely thin film of the conductive polymer in the graft polymer formation region on the base material. In this manner, uniform and thin conductive polymer layer can be obtained.

Any conductive polymers may be used as the conductive polymer used in this method as long as it is a polymer compound having conductivity of 10⁻⁶ s·cm⁻¹ or above or preferably 10⁻¹ s·cm⁻¹ or above. Specific examples include substituted or unsubstituted conductive polyaniline, substituted or unsubstituted polyparaphenylene, substituted or unsubstituted polyparaphenylenevinylene, substituted or unsubstituted polythiophene, polyfuran, substituted or unsubstituted polypyrrole, substituted or unsubstituted polyselenophene, substituted or unsubstituted polyisothianaphthene, substituted or unsubstituted polyphenylenesulfide, substituted or unsubstituted polyacetylene, polypyridylvinylene, and substituted or unsubstituted polyazine. These can be used alone or in combination of two or more kinds according to its need. Also, mixtures with other polymers having no conductivity, or copolymers of those monomers and other monomers having no conductivity can be used as long as they are within the range of achieving the desirable conductivity.

In the invention, since the conductive monomer itself strongly adsorbs to the interactive group of the graft polymer by forming an interaction electrostatically or polarity, the conductive polymer layer formed by a polymerization of those monomers forms a strong interaction between the conductive polymer layer and the graft polymer formation regions, and thus it becomes to have a sufficient strength against rubbing or scratching although it is a thin film.

In addition, when materials capable of being adsorbed with relationship of a cation and an anion are selected for the conductive polymer and the interactive group of the graft polymer, the conductive polymer is adsorbed as a counter-anion of the conductive polymer, and functions as a dopant. Therefore an effect of further improving conductivity of the conductive polymer layer (conductivity development layer) can be achieved. In specific, for example, when styrenesulfonic acid is selected as a polymerizable compound having an interactive group and thiophene is selected as a conductive polymer material respectively, polythiophene having sulfonic acid (sulfone group) as a counter-anion exists in interface of the graft polymer formation region and conductive polymer layer, and it becomes to function as the dopant.

A film thickness of the conductive polymer layer formed on a surface of the graft polymer formation region is not specifically limited, and it is preferably in the range of 0.01 to 10 μm and more preferably 0.1 to 5 μm. If the film thickness of the conductive polymer layer is in this range, sufficient conductivity and transparency can be achieved. The thickness of 0.01 μm or less is not preferable since the conductivity may become insufficient.

By the four embodiments described above, the method for forming the conductive pattern in the invention can be carried out and the conductive region (conductive pattern) having excellent adhesion and resolution can be formed on the substrate.

This conductive pattern can favorably be used as a wiring or an electrode of electronic materials, and is suitably applied to a thin film transistor.

### EXAMPLES

### Synthesis Example 1

### Synthesis of Hydrophilic Polymer P Having a Polymerziable Group

18 g of polyacrylic acid (average molecular weight of 25,000) was dissolved in 300 g of DMAc (dimethylacetoamide) and 0.4 μg of hydroquinone was further added together with 19.4 g of 2-methacryloyloxyethylisocyanate and 0.25 g of dibutyltindilaurate, and carried out a 4 hour reaction at 65° C. An acid value of the obtained polymer was 7.02 meq/g. A carboxyl group was neutralized with 1 mol/l of sodium hydroxide aqueous solution, and the resultant was added to ethyl acetate to precipitate a polymer, followed by washing well, and then obtained a hydrophilic polymer P having a polymerizable group.

### Example 1

### Photocleavable Compound Bonding Process

UV ozone treatment was carried out on a glass substrate (manufactured by Nippon Sheet Glass) for 5 minutes by using a UV Ozone cleaner (trade name: UV42, manufactured by Nippon Laser Electronic Corp.). A solution of 1.0% by mass of compound T1 (exemplary compound T1 shown above) prepared by dissolving the compound T1 in dehydrated toluene was spin coated on the substrate surface. The spin coater was rotated first at 300 rpm for 5 seconds and then rotated at 1000 rpm for 20 seconds. The glass substrate on which the compound T1 had been spin coated was dried at 100° C. for 2 minutes, the surface was washed with toluene, acetone, and water one after the other in this order, and dried with an air gun. Next, toluene solution of 1.0% by mass of the compound S1 shown below was coated on the substrate by using a spin coater which was rotated first at 300 rpm for 5 seconds and then at 1000 rpm for 20 seconds. In this manner, a substrate A1 was obtained.

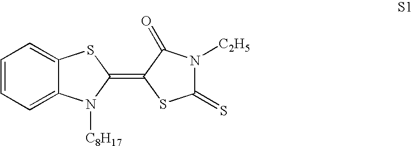

(Graft Polymer Formation Process)

0.25 g of hydrophilic polymer P obtained in the aforementioned synthesis example 1 was dissolved in a mixture solvent containing 1.91 g of water, 0.09 g of dimethylacetoamide (DMAc) and 1 g of acetonitrile so as to prepare a coating solution for a graft forming layer. The coating solution for a graft forming layer was spin coated on the substrate A1 surface. The spin coater was rotated first at 300 rpm for 5 seconds and then rotated at 1000 rpm for 20 seconds. The substrate A1 coated with the coating solution for a graft forming layer was dried at 80° C. for 5 minutes.

(Exposure)

The substrate A1 coated with the coating solution for a graft forming layer was exposed according to a predetermined pattern by a laser exposure apparatus having a transmission wavelength of 405 nm. After the exposure, the substrate surface was washed with water while being lightly rubbed with wiper (trade name: BEMCOT, manufactured by Ozu Corporation), and then washed with acetone.

In this manner, glass substrate B1 in which the graft polymer is formed patternwise on the surface was formed.

The obtained pattern was observed with AFM (trade name: NANOPIX 1000, manufactured by Seiko Instruments Inc.). As a result, it was confirmed that on the glass substrate B1, a pattern having a line having a width of 10 μm and a gap having a width of 10 are arranged alternatively, was formed.

(Application of Conductive Material)

(Electroless Plating)

The obtained substrate B1 was immersed in 0.1% of silver nitrate (manufactured by Wako Pure Chemicals Industry) aqueous solution for 5 minutes, washed with water and dried with air gun. Next, it was immersed for 20 minutes in an electroless plating bath (pH: 12.7) having a composition described below and carried out an electroless plating. After the electroless plating, it was washed with water and dried with air gun.

<Composition of Electroless Plating Bath>

Water 300 g

Cupper sulphate (II) pentahydrate 4.5 g

Triethanolamine 8.04 g

Polyethyleneglycol

(average molecular weight 1000) 0.03 g

Sodium hydroxide 2.7 g

Formaldehyde solution (36.0 to 38.0%) 5.4 g

When the surface was observed with the microscope, it was confirmed that a conductive pattern 1 having a line having a width of 10 μm and a gap having a width of 10 μm alternatively arranged, was formed.

### Example 2

The glass substrate B1 prepared in the example 1 in which the graft polymer is formed on the surface was immersed in 0.1% of silver nitrate (manufactured by Wako Pure Chemicals Industry) aqueous solution for 5 minutes, then washed with water and dried with air gun. Next, it was immersed for 20 minutes in an electroless plating bath (pH: 12.4) having a composition described below and carried out electroless plating. After carrying out electroless plating, it was washed with water and dried with air gun.

<Composition of the Electroless Plating>

Water 200 g

Copper sulfate (II) pentahydrate 2.9 g

Potassium sodium (+)-tartrate tetrahydrate 21.3 g

Sodium hydroxide 1.65 g

Formaldehyde solution (36.0 to 38.0%) 5.5 ml

Water was added to make a total volume of 250 ml.

When the surface was observed with the microscope, it was confirmed that a conductive pattern 2 having a line having a width of 10 μm and a gap having a width of 10 arranged alternatively, was formed.

### Example 3

(Photocleavable Compound Bonding Process)

UV ozone treatment was carried out on a glass substrate (manufactured by Nippon Sheet Glass) for 5 minutes by using a UV Ozone cleaner (trade name: UV42, manufactured by Nippon Laser Electronic Corp.). A solution of 5.0% by mass of compound T5 shown below (exemplary compound T5 shown above) prepared by dissolving the compound T5 in dehydrated ethylmethyl ketone (2-butanone) was spin coated on the substrate surface. The spin coater was rotated first at 300 rpm for 5 seconds and then rotated at 1000 rpm for 20 seconds. The glass substrate on which the compound T5 shown below had been spin coated was dried at 100° C. for 10 minutes, the surface was washed with ethylmethyl ketone and water one by one in this order, and dried with an air gun. In this manner, a substrate A2 was obtained.

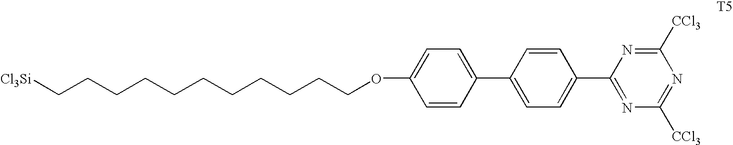

(Graft Polymer Formation Process)

0.25 g of hydrophilic polymer P obtained in the aforementioned synthesis example 1 was dissolved in a mixture solvent containing 1.91 g of water, 0.09 g of dimethylacetoamide (DMAc) and 1 g of acetonitrile, and further, 0.02 of S2 (sensitizer) shown below was added and dissolved therein, so as to prepare a coating solution for a graft forming layer. The coating solution for a graft forming layer was spin coated on the substrate A2 surface. The spin coater was rotated first at 300 rpm for 5 seconds and then rotated at 1000 rpm for 20 seconds. The substrate A2 coated with the coating solution for a graft forming layer was dried at 80° C. for 5 minutes.

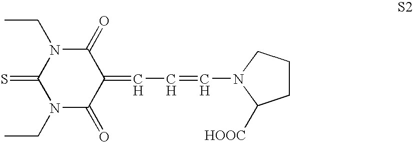

(Exposure)

The substrate A2 coated with the coating solution for a graft forming layer was exposed according to a predetermined pattern by a laser exposure apparatus having a transmission wavelength of 405 nm. After the exposure, the substrate surface was washed with water while being lightly rubbed with wiper (trade name: BEMCOT, manufactured by Ozu Corporation), and then washed with acetone.

In this manner, glass substrate B2 in which the graft polymer is formed patternwise on the surface was formed.

The obtained pattern was observed with AFM (trade name: NANOPIX 1000, manufactured by Seiko Instruments Inc.). As a result, it was confirmed that on the glass substrate B2, a pattern having a line having a width of 10 μm and a gap having a width of 10 are arranged alternatively, was formed.

### Example 4

(Photocleavable Compound Bonding Process)

UV ozone treatment was carried out on a glass substrate (manufactured by Nippon Sheet Glass) for 5 minutes by using a UV Ozone cleaner (trade name: UV42, manufactured by Nippon Laser Electronic Corp.). A solution of 1.0% by mass of compound T1 (the exemplary compound T1 shown above) prepared by dissolving the compound T1 in dehydrated toluene was spin coated on the substrate surface. The spin coater was rotated first at 300 rpm for 5 seconds and then rotated at 1000 rpm for 20 seconds. The glass substrate on which the compound T1 had been spin coated was dried at 100° C. for 2 minutes, the surface was washed with toluene, acetone, and water one after the other in this order, and dried with an air gun. Next, toluene solution of 1.0% by mass of the compound S1 shown above was coated on the substrate by using the spin coater which was rotated first at 300 rpm for 5 seconds and then at 1000 rpm for 20 seconds. In this manner, a substrate A1 was obtained

(Graft Polymer Formation Process)

0.25 g of hydrophilic polymer P obtained in the aforementioned synthesis example 1 was dissolved in a mixture solvent containing 1.91 g of water, 0.09 g of dimethylacetoamide (DMAc) and 1 g of acetonitrile, and further, 0.02 of S2 (sensitizer) shown above was added and dissolved therein, so as to prepare a coating solution for a graft forming layer. The coating solution for a graft forming layer was spin coated on the substrate A1 surface. The spin coater was rotated first at 300 rpm for 5 seconds and then rotated at 1000 rpm for 20 seconds. The substrate A1 coated with the coating solution for a graft forming layer was dried at 80° C. for 5 minutes.

(Exposure)

The substrate A1 coated with the coating solution for a graft forming layer was exposed according to a predetermined pattern by a laser exposure apparatus having a transmission wavelength of 405 nm. After the exposure, the substrate surface was washed with water while being lightly rubbed with wiper (trade name: BEMCOT, manufactured by Ozu Corporation), and then washed with acetone.

In this manner, glass substrate B3 in which the graft polymer is formed patternwise on the surface was formed.

The obtained pattern was observed with AFM (trade name: NANOPIX 1000, manufactured by Seiko Instruments Inc.). As a result, it was confirmed that on the glass substrate B3, a pattern having a line having a width of 10 μm and a gap having a width of 10 are arranged alternatively, was formed.

### Example 5

The glass substrate B2 prepared in the example 3 in which the graft polymer is formed on the surface was immersed in 1.0% of silver nitrate (manufactured by Wako Pure Chemicals Industry) aqueous solution for 1 minute, then washed with water and dried with air gun. Next, it was immersed for 90 minutes in a commercial electroless plating bath ATS ADCUPPER (pH: 12.7) having a composition described below and carried out electroless plating. After carrying out electroless plating, it was washed with water and dried with air gun.

<Composition of the electroless plating>

| | | |
|---|---|---|
| Water | 258 | g |
| ATS ADCUPPER IW-A | 15 | mL |
| ATS ADCUPPER IW-M | 24 | mL |
| ATS ADCUPPER IW-C | 3 | mL |

When the surface was observed with the microscope, it was confirmed that a conductive pattern 3 having a line having a width of 10 μm and a gap having a width of 10 arranged alternatively, was formed.

### Example 6

The glass substrate B2 prepared in the example 3 in which the graft polymer is formed on the surface was immersed in 1.0% of silver nitrate (manufactured by Wako Pure Chemicals Industry) aqueous solution for 1 minute, then washed with water and dried with air gun. Next, it was immersed for 20 minutes in a electroless plating bath (pH: 12.4) having a composition described below and carried out electroless plating. After carrying out electroless plating, it was washed with water and dried with air gun.

<Composition of the electroless plating>

| | | |
|---|---|---|
| Water | 300 | g |
| Cupper sulphate (II) pentahydrate | 3.0 | g |
| EDTA-4H dihydrate | 8.9 | g |
| Polyethylene glycol | 0.03 | g |
| (average molecular weight 1000) | | |
| 2,2′-bipyridyl | 0.03 | mg |
| Ethylene diamine | 0.12 | g |
| Tetramethylammonium hydroxyde pentahydrate | 2.5 | g |
| Formaldehyde solution (36.0 to 38.0%) | 1.6 | g |

When the surface was observed with the microscope, it was confirmed that a conductive pattern 4 having a line having a width of 10 μm and a gap having a width of 10 arranged alternatively, was formed.

<Evaluation of Conductivity>

For the conductive patterns 1 to 4 obtained in the above manner, conductivity of the surface of the part on which conductive film is formed was measured by a four probe method using a conductivity meter (trade name: LORESTA-FP, manufactured by Mitsubishi Chemical Corporation.). The results are shown below.

<Evaluation of Conductive Film Adhesion>

Conductive region (conductive film) was formed on a region of 10 (mm)×200 (mm) in the same manner as the conductive patterns 1 to 4, and film adhesion was evaluated by a grid tape method based on JIS 5400. A stripping test of the tape to a cut grid was carried out. Remained numbers of grid on the substrate side among the 100 grids are shown below.

<Evaluation Result>

### Example 1

Conductivity of conductive pattern 1: 50 μΩ·cm

Result of the stripping test: 100 (stripping is not shown)

### Example 2

Conductivity of conductive pattern 2: 40 μΩ·cm

Result of the stripping test: 100 (stripping is not shown)

### Example 5

Conductivity of conductive pattern 3: 10 μΩ·cm

Result of the stripping test: 100 (stripping is not shown)

### Example 6

Conductivity of conductive pattern 4: 7 μΩ·cm

Result of the stripping test: 100 (stripping is not shown)

From the above results, it is found that a graft polymer pattern having high resolution can be easily obtained by the method of the invention. Further, it is confirmed that the conductive pattern obtained by applying a conductive material to the graft pattern obtained by the method of the invention has high resolution, the conductive region formed therein has conductivity, and the conductive pattern has excellent adhesion to the substrate.

According to an aspect of the invention, a graft pattern forming method capable of forming a graft pattern which has excellent adhesion to the substrate and a capability of easily forming a functional pattern by applying various functional materials to a desirable region, using an inexpensive apparatus, can be provided.

According to another aspect of the invention, a conductive pattern forming method capable of easily forming a conductive pattern having excellent adhesion to a substrate and conductivity using an inexpensive apparatus, is provided.

The conductive pattern obtained by this conductive pattern forming method has higher resolution, and superior adhesion and conductivity compared with those obtained by the conventional method, and thus it is advantageous in various apparatuses requiring a wiring having high resolution.

Hereinafter embodiments of the invention will be described. However, the invention is not limited to the following embodiments.

<1> A graft pattern forming method comprising:

contacting a radical-polymerizable unsaturated compound with a surface of a base material capable of generating radicals by exposure; and

exposing imagewise with laser light having a wavelength of from 360 to 700 nm, to form a graft polymer directly bonded to the base material patternwise on the surface of the base material.

<2> A graft pattern forming method of embodiment <1>, wherein the base material comprises a polymerization initiator and a sensitizer having maximum absorption at a wavelength of from 360 to 700 nm.

<3> A graft pattern forming method of embodiment <2>, wherein the polymerization initiator is a triazine polymerization initiator.

<4> A graft pattern forming method of embodiment <1>, wherein the contacting the radical-polymerizable unsaturated compound with the surface of the base material comprises contacting a layer including the radical-polymerizable unsaturated compound and a sensitizer having maximum absorption at a wavelength of from 360 to 700 nm, with the base material.

<5> A conductive pattern forming method comprising imparting conductivity to the graft polymer formed patternwise obtained by the graft pattern forming method of embodiment <1>.

<6> A conductive pattern forming method of embodiment <5>, wherein imparting of conductivity to the graft polymer comprises applying a conductive material to the graft polymer.

<7> A conductive pattern forming method of embodiment <5>, wherein the base material comprises a polymerization initiator and a sensitizer having maximum absorption at a wavelength of from 360 to 700 nm.

<8> A conductive pattern forming method of embodiment <7>, wherein the polymerization initiator is a triazine polymerization initiator.

<9> A conductive pattern forming method of embodiment <5>, wherein the contacting the radical-polymerizable unsaturated compound with the surface of the base material comprises contacting a layer including the radical-polymerizable unsaturated compound and a sensitizer having maximum absorption at a wavelength of from 360 to 700 nm, with the base material.

<10> A conductive pattern forming method of embodiment <6>, wherein the applying the conductive material to the graft polymer comprises adsorbing an electroless plating catalyst or a precursor thereof to an ionic group of the graft polymer, and forming a plating film by carrying out electroless plating.

<11> A conductive pattern forming method of embodiment <10>, wherein the electroless plating uses an electroless plating bath containing trialkanolamine.

The disclosure of Japanese Patent Application No. 2005-148359 is incorporated by reference herein in its entirety.

All publications, patent applications, and technical standards mentioned in this specification are herein incorporated by reference to the same extent as if each individual publication, patent application, or technical standard was specifically and individually indicated to be incorporated by reference.

1. A graft pattern forming method comprising:
contacting a radical-polymerizable unsaturated compound with a surface of a base material capable of generating radicals by exposure; and
exposing imagewise with laser light having a wavelength of from 360 to 700 nm to form a graft polymer directly bonded to the base material patternwise on the surface of the base material.

2. The graft pattern forming method of claim 1, wherein the base material comprises a polymerization initiator and a sensitizer having maximum absorption at a wavelength of from 360 to 700 nm.

3. The graft pattern forming method of claim 2, wherein the polymerization initiator is a triazine polymerization initiator.

4. The graft pattern forming method of claim 1, wherein the contacting the radical-polymerizable unsaturated compound with the surface of the base material comprises contacting a layer including the radical-polymerizable unsaturated compound and a sensitizer having maximum absorption at a wavelength of from 360 to 700 nm, with the base material.

5. A conductive pattern forming method comprising imparting conductivity to the graft polymer formed patternwise obtained by the graft pattern forming method of claim 1.

6. The conductive pattern forming method of claim 5, wherein the imparting of conductivity to the graft polymer comprises applying a conductive material to the graft polymer.

7. The conductive pattern forming method of claim 5, wherein the base material comprises a polymerization initiator and a sensitizer having maximum absorption at a wavelength of from 360 to 700 nm.

8. The conductive pattern forming method of claim 7, wherein the polymerization initiator is a triazine polymerization initiator.

9. The conductive pattern forming method of claim 5, wherein the contacting the radical-polymerizable unsaturated compound with the surface of the base material comprises contacting a layer including the radical-polymerizable unsaturated compound and a sensitizer having maximum absorption at a wavelength of from 360 to 700 nm, with the base material.

10. The conductive pattern forming method of claim 6, wherein the applying the conductive material to the graft polymer comprises adsorbing an electroless plating catalyst or a precursor thereof to an ionic group of the graft polymer, and forming a plating film by carrying out electroless plating.

11. The conductive pattern forming method of claim 10, wherein the electroless plating uses an electroless plating bath containing trialkanolamine.
